(19) United States
(12) Patent Application Publication
(10) Pub. No.: US 2006/0285913 A1
(43) Pub. Date: Dec. 21, 2006

(54) Twist-open dispenser with applicator & method of applying skin care products & method of merchandising paint

(75) Inventor: Kurt Koptis, Yucca Valley, CA (US)

Correspondence Address: CONNORS ASSOCIATES, 1600 DOVE ST, SUITE 220, NEWPORT BEACH, CA, 92660, US

(73) Assignee: Platinum Innovations. Inc.

(21) Appl. No.: 11/155,015

(22) Filed: Jun. 16, 2005

(51) Int. Cl. B43K 5/00; B43M 11/06

(52) U.S. Cl. 401/205; 401/202; 401/183

(57) ABSTRACT

A dispenser cap with an applicator is connected to a container and a detachable enclosure protects the applicator when the dispenser is not in use. When attached to the cap, the enclosure has a pin that blocks an opening in the cap. The container may hold any fluid material, for example, a skin care product, deodorant, paint, etc. The container may contain various means of identifying the color of paint contained therein, and only a small amount of paint is within the container. This enables a consumer to obtain a number of containers each holding a paint of a different color to apply to a test surface.

### RELATED DISCLOSURE DOCUMENT & INCORPORATION BY REFERENCE

This dispenser to which this application is directed was disclosed in Disclosure Document No. 540632 deposited on Oct. 22, 2003, with United States Patent and Trademark Office. This disclosure document is incorporated herein by reference and made a part of this application. If any conflict arises between the disclosure of the invention in this utility application and that in the disclosure document, the disclosure in this utility application shall govern.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

“Rectangular shape” includes square shape.

“Paint color(s)” includes both the pigment of the paint as well as the gloss level.

### BACKGROUND OF INVENTION

Dispensers with an applicator attached to a container are known for dispensing a wide variety of fluid materials held within the container such as, for example, (a) skin care products such as, for example, cosmetics, micro-dermal abrasive solutions, antiseptics, ointments, creams, topical solutions, etc. (b) deodorant, (c) depilatory creams, (d) shoe cleaners and polish, (e) coatings such as, for example, paint, stains, varnish, liquid wax, many types of chemicals, etc. Sometimes these dispensers leak. Moreover, it would be desirable to have a dispenser particularly useful for sampling different paint colors by applying different colors to various surfaces. For example, when a consumer desires to paint an object, they go to a hardware or paint store where they browse through hundreds of different color samples on small cards. After narrowing their choices down to a few colors they select the corresponding cards having the desired choices. The cards are then brought to the item to be painted where they are held up next to the object they intend to paint. Unfortunately at no point in this process is the consumer able to see what the paint will actually look like on the object they intend to paint. Additionally, the paint on the cards often does not come in the different gloss levels and this further adversely affects the selection process, perhaps resulting in a paint selection that is undesired.

### SUMMARY OF INVENTION

This invention provides a dispenser that may be used to dispense and apply a wide variety of fluid materials, including, but not limited to, skin care products, liquid wax, stains, varnish, depilatory creams, gels of many types, micro-dermal abrasive solutions, shoe cleaning chemicals, paint, deodorant, etc. The dispenser is designed so the consumer may control when the contents of the container are dispensed and, until then, the contents are safely sealed therein. Additionally, the dispenser includes an applicator adapted to apply the fluid material within the container directly to a desired surface.

One embodiment of the dispenser of this invention comprises a container adapted to hold a fluid material, a cap attached to a dispensing end of the container, and a detachable top enclosure mounted to the cap. The cap includes a base member and a cover member and a passageway there through which allows the fluid material to flow out of the container and onto the desired surface. The base member is attached to the dispensing end of the container and the cover member is attached to the base member. The exterior of the cover member has an applicator element onto which flows the material exiting the container. The base and cover members are mounted to each other to be rotated between a closed position preventing the flow of the fluid material through the passageway and an open position allowing the flow of material from the container and through the passageway onto the applicator element. The detachable top enclosure covers the applicator element and at least partially blocks the passageway.

The invention has one or more features as discussed subsequently herein. After reading the following section entitled “DETAILED DESCRIPTION OF SOME EMBODIMENTS OF THIS INVENTION,” one will understand how the features of this invention provide its benefits. The benefits of this invention include, but are not limited to: (a) providing a dispenser that has a cap that is normally closed but may be opened to allow a consumer to dispense a fluid material, (b) providing a dispenser that has a cap that may be opened or closed, and when closed fluid material in the dispenser does not leak, (c) providing a detachable enclosure for a dispenser that includes an abrasive surface for filing, sanding, smoothing, or any other similar purpose, (d) providing a detachable enclosure including an internal pin that helps keep the dispenser sealed, (e) providing an applicator that is made of a soft material that is capable of absorbing and spreading fluid material being dispensed and that accommodates an internal pin in a dispenser top enclosure, (f) providing an applicator that may be made of a stiffer material, for example, flexible bristles, that is capable of scrubbing a surface in order to clean it, (g) providing a dispenser with multiple barriers or seals inhibiting or preventing leakage, (h) providing a dispenser for paint that has more functionality than a standard paint can by not only providing a device for storing the paint but also including an attached applicator, (i) providing a method that allows a consumer to sample different paint colors by applying a selected paint color contained within the dispenser to an object to be painted via an attached applicator, (j) providing an applicator that is made of a rigid material, for example, plastic, that has a dome shape and a plurality of openings to be used as a deodorant applicator, and (k) having a top enclosure that protects the applicator, seal the container and provides storage for additional replacement applicators.

Without limiting the scope of this invention as expressed by the claims that follow, some, but not necessarily all, of its features are:

One, the container is adapted to hold a fluid material and has a dispensing end from which this material is dispensed. A cap is attached to the dispensing end and it may include a base member and a cover member attached to the base member. The base and cover members may be mounted to move relative to each other, so that in a first position the flow of material is prevented and in a second position the flow of material is allowed. These members may each have an opening therein, and they may be operatively connected in such a manner that their respective openings are aligned with each other. The base and cover members may be mounted to rotate relative to each other to move between the first and second positions, maintaining the alignment of the openings during rotational movement. The base member may be fixedly attached to the container. Rotating the cover member in one direction relative to the base member causes the cover member and base member to separate from each other but not change the alignment of their openings. Such separation of these members opens the dispenser, moving from the first position in which the cap is sealed and no fluid material can escape to the second position in which the consumer is able to release the fluid material from within the container, for example, by squeezing the container. In one embodiment the base and cover member each have substantially the same length and the cover member has a width that is substantially less than the width of the base member. Consequently, in the closed position the base and cover members are aligned lengthwise and in the open position the cover member is oriented at an angle with respect to the base member. Thus the consumer may easily identify whether the cap is in the open or closed position.

Two, the applicator element may be fixedly or detachably connected to the cover member. By having the applicator detachably connected to the cover member, the consumer may easily remove the applicator to either clean it or dispose of it after using it and then replace it with either the freshly cleaned, original applicator, or a new, fresh, applicator. The cover member may include a raised peripheral element surrounding a lower portion of the applicator element. The applicator element may have many forms. It may be resilient, for example, it may comprise a material that absorbs the fluid material flowing through the openings when the base and cover members are in the second position, for example, a sponge. It may be stiff, for example, bristles for scrubbing. It may be a dome with orifices through which a deodorant is dispensed. It may have an exposed flocked surface; it may have a slanted top surface. Additionally, the applicator may have different cross-sectional shapes: For example, it may be circular, oval, cross-shaped, rectangular, or triangular. The applicator does not have to be made of the same material throughout nor of the same density throughout; it may be made of multiple layers, for example there may be a layer of high density absorbent material close to the cover member and a layer of low density absorbent material on the end of the applicator furthest from the cover member.

Three, the container may serve as a handle that enables a consumer to squeeze it when the cap is in the second open position to apply the contents of the container onto a surface. The container may be made of a soft malleable plastic that allows for the easy compression thereof. The container may be blow molded for ease of manufacture. With a blow-molded container, a rigid insert at the dispensing end of the container is used to assist in mounting the cap to the container. Holding the container with one hand and with the cap in the open position, the consumer squeezes the container and uses the applicator to spread the applied contents over a surface. By having the applicator attached to the dispenser cap it becomes very convenient for the consumer to apply the contents stored within the container by squeezing the container to push some or all of its contents onto the applicator. The applicator may have a passageway that is interactive with the top enclosure for sealing purposes. This passageway may also assist applying the contents onto other portions of the applicator. It may be centrally located and extend longitudinally, and it may be axially aligned with the opening or openings in the base and cover members. Also, there may be a plurality of passageways in the applicator.

Four, the detachable enclosure includes an internal pin element that interacts with the cover member to provide a secondary seal when the enclosure is attached to the cap. For example, a tip of the pin element may extend into the opening in the cover member. Or, a tip of the pin element may abut and apply pressure to an end of a plug element extending into the opening in the cover member. Or, a tip of the pin element may extend into a passageway or orifice in the applicator. This secondary seal increases the quality of the overall seal of the dispenser cap when in the closed position, and is especially helpful in preventing leakage during shipment and displaying for sale. Additionally, the secondary seal prevents accidental spills should the consumer put the top enclosure on, but forget to return the dispenser cap to the first closed position. This pin element may extend away from an interior surface of an enclosure top wall in a substantially perpendicular direction towards an open bottom end of the enclosure. The open bottom end has a configuration that enables the enclosure to fit snugly onto the cap. The internal pin element is long enough that it can pass through the entire length of the passageway in the applicator to engage the cover member when attached to the cap. In one embodiment the enclosure has a number of pins that pass through and seal an equal number of openings in a dome shaped applicator that may be used, for example, to apply deodorant.

In one embodiment, the internal pin element has at an inner terminal end a hollow cylindrical wall defining a cavity. The cylindrical wall fits tightly within a similarly cylindrical shaped central indentation or groove in the cover member that substantially surrounds the opening in the cover member. Thus, when the cover and base members are in the closed position and the top enclosure in place on the cap, a tight seal is provided and the top enclosure is held securely in place on the dispenser cap. In another embodiment, a raised wall substantially surrounding the opening in the cover member provides an open space and the internal pin element has an inner terminal end that fits snugly into this open space when the base and cover members are in the closed position. The enclosure may include a closed top end and an inward projecting retainer element at the open bottom end, enabling the enclosure to be detachably connected to an edge of the cover member or the base member. The enclosure may have an external abrasive surface, for example at its closed top end, and the enclosure may include at least one vent opening.

Five, the base member may include a plug element that seals the opening in the cover member. When the dispenser cap is in the first, closed position, the plug element may fit snugly within the opening in the cover member or it may press against a bottom tip of the internal pin element of the top enclosure, thereby sealing the fluid material inside the container and not allowing any seepage. When the consumer rotates the cover member in one direction relative to the base member, the plug element disengages and separates from the cover member, thereby breaking the seal and allowing the contents of the container to be dispensed.

Six, the dispenser cap may include at least one stop element that inhibits rotational movement of the cover member relative to the base member. Upon opening the cap, the stop element may indicate that the cap is in the completely open position when the stop element is reached. For example, the consumer feels that continued rotation is impeded. The stop element may be such that the consumer can continue to twist the cover member relative to the base member, moving past the stop element by applying an additional amount of torsional force, thereby detaching the cover member from the base member. When reattaching the cover member, again an additional amount of torsional force is needed to overcome the impediment of the stop element. As long as the cover member is between the first and second positions the cover member turns freely. A clicker member may also be a component of the cap. It provides an audible signal when the cover member is moved into the completely closed position and also upon moving from the completely closed into an open position.

Seven, the dispenser may include multiple seals. For example, mating annular elements may be located on different portions of the base and cover member, or mating annular elements may be located on different portions of the pin element and the base member or the pin element and the cover member. For example, the pin element may include at least one annular element that is in a mating relationship with an annular element on a plug element on the base member that fits in the opening when the cover member is in the closed position. The cover and base members also may each include at least one annular element, and these annular elements are aligned to mate with each other when the cover member is in the closed position.

Eight, the outside surface of the container may include indicia that identifies the contents therein. Some of the possible indicia include, but are not limited to, a numerical code number representing the particular paint color, a plain descriptive name of the color of paint, a machine readable pattern, such as a barcode, representing the color the paint. The plurality of indicia makes it easier for the consumer to communicate the desired paint color, and for the retailer to be able to determine the color inside the container for future sales.

These features are not listed in any rank order nor is this list intended to be exhaustive.

This invention also includes an improved paint selection and merchandising method where the consumer uses a dispenser holding only a small sample of the color paint they anticipate will provide the desired color with the expected gloss level when applied to the object being painted. Consequently, the consumer only buys a small quantity of paint. Moreover, the dispenser may be used for small touch up work or for painting small objects. Additionally, when using the dispenser of this invention, the consumer does not need to purchase a paintbrush. One embodiment of the method of this invention comprises:

(a) providing at a sales source a plurality of compact paint dispensers from which a consumer selects one or more, each individual dispenser containing a paint of a predetermined color and including a paint applicator having a manually actuated open and closure mechanism to enable a consumer to release selectively paint therefrom,

(b) using one or more paint dispensers obtained from the sales source, applying as a specimen of paint from a selected dispenser to a test surface to enable a consumer to identify a desired color of paint to be used to paint the surface with a quantity of paint substantially greater than that contained within an individual dispenser or dispensers being used to apply paint to the test surface, and

(c) subsequent to step (b), ordering a larger quantity of paint and identifying the color of paint being ordered.

The attached applicator can be used like a brush to spread the paint over the surface, typically at a location remote from the sales source. Once the paint has been applied and given enough time to dry the consumer then selects the desired color and relates that information to the store where he or she can then purchase the larger quantities of the desired paint color, typically at least one quart or more. Typically, the individual dispensers may contain no more than about 8 ounces of a particular color of a paint and may include indicia thereon that identifies the color of the paint therein. The indicia may be machine-readable. In that case, an order is placed by returning the dispenser to the sales source to enable the indicia to be machine read at this source. The indicia may be imprinted on the dispenser in a form understandable to a human consumer to enable a human consumer to place an order with the sales source, for example by telephone or over the internet, using the human readable indicia to identify the color of paint being ordered. A label may contain the name or identification number of the color selected or a bar code or all of these indicia identifying the paint color in the container. By putting this information on the container the consumer does not have to remember what paint color was in what container, and if they like the color, it is very simple and error proof for an employee at the sales source to mix a larger quantity of the same color paint.

The invention also includes a method of applying a fluid skin care product to the skin of a person. A dispenser is used having a container holding a fluid skin care product, a twist-open cap on the container, an applicator attached to the cap, a passageway through which the skin care product flows upon twisting the cap open, and a detachable enclosure mounted to the cap that covers the applicator and at least partially blocks the passageway. In accordance with this method, the enclosure is removed, the cap is twisted open, and the applicator is used to apply the skin care product to the skin of the person.

### DESCRIPTION OF THE DRAWING

Some embodiments of this invention, illustrating all its features, will now be discussed in detail. These embodiments depict the novel and non-obvious dispenser and method of this invention as shown in the accompanying drawing, which is for illustrative purposes only. This drawing includes the following figures (Figs.), with like numerals indicating like parts:

FIG. 1 is a perspective view, with sections broken away, of one embodiment of the dispenser of this invention with a dispenser cap attached to a container and the cap in the closed position and a top enclosure in place.

FIG. 2 is an exploded perspective view of the dispenser shown in FIG. 1.

FIG. 3 is a fragmentary cross-sectional view taken along line 3-3 of FIG. 1.

FIG. 3A is a fragmentary cross-sectional view similar to FIG. 3 with the dispenser cap in an open position and the top enclosure removed and elevated above the dispenser cap.

FIG. 4 is a fragmentary perspective view, with sections broken away, of the exterior surface of the top wall of the cover member of dispenser cap shown in FIG. 1, with the applicator shown in phantom lines and the tip of an internal pin in the top enclosure elevated above the center of the cover member.

FIG. 4A is an enlarged fragmentary cross-sectional view of an alternate embodiment of the cover member of the dispenser cap employed in this invention with an alternate embodiment of the internal pin, elevated above the center of the cover member.

FIG. 5 is a perspective view of an applicator having a flocked surface.

FIGS. 6A through 6D show a third embodiment of the dispenser of this invention employing a modified conventional dispenser cap, where FIG. 6A is a plan view of an underside of a dispenser cap's cover member taken along line 6A-6A of FIG. 6C.

FIG. 6B is a cross-sectional view of the third embodiment of the dispenser of this invention in the closed position and with the top enclosure secured in place.

FIG. 6C is a cross-sectional view similar to that of FIG. 6B showing a detached cover member.

FIG. 6D is a fragmentary cross-sectional view taken along line 6D-6D of FIG. 6A.

FIGS. 7 through 7I show a fourth embodiment of the dispenser of this invention, where:

FIG. 7 is an exploded perspective of the fourth embodiment of the dispenser of this invention.

FIG. 7A is a cross-sectional view of the embodiment shown in FIG. 7 with a top enclosure attached.

FIG. 7B is a cross-sectional view of the dispenser cap shown in FIG. 7A in an open position and with a top enclosure detached.

FIG. 7C is a plan view of a topside of a dispenser cap's base member taken along line 7C-7C of FIG. 7B.

FIG. 7D is an enlarged, fragmentary cross-sectional view of the area enclosed by a circular line 7D of FIG. 7A showing the interlocking of the top enclosure to the dispenser cap.

FIG. 7E is an enlarged, fragmentary cross-sectional view of the area enclosed by a circular line 7E of FIG. 7A showing a sealing between the cover member and the base member.

FIG. 7F is an enlarged, fragmentary cross-sectional view of the area enclosed by a circular line 7F of FIG. 7A showing the enclosure pin inserted into the cover member opening to further seal the dispenser.

FIG. 7G is an enlarged, fragmentary cross-sectional view of the area enclosed by a circular line 7G of FIG. 7B showing a stop mechanism.

FIG. 7H is an enlarged, fragmentary cross-sectional view of the dispenser shown in FIG. 7B with the top enclosure removed and the cap opened to allow fluid material to be dispensed.

FIG. 7I is an enlarged, fragmentary cross-sectional view of the area enclosed by a circular line 7I of FIG. 7A showing the matched pair of threads of the cover member and base member.

FIG. 8 is an enlarged, fragmentary view, partially in cross-section, of an alternate embodiment of the dispenser of this invention employing an applicator having a slanted top surface.

FIG. 9 is a perspective view of an alternate embodiment of an enclosure having a plurality of ventilation holes used in the dispenser of this invention.

FIG. 10 is a perspective view of an alternate embodiment of the dispenser of this invention employing a dispenser cap and applicator having a triangular shape.

FIG. 11A is a perspective view of an alternate embodiment of the dispenser of this invention employing a dispenser cap and applicator having a hexagonal shape.

FIG. 11B is a perspective view of an alternate embodiment of the dispenser of this invention employing a dispenser cap and applicator having a square shape.

FIG. 11C is a perspective view of an alternate embodiment of the dispenser of this invention employing a dispenser cap and applicator having a cross shape.

FIG. 12A is a plan view of an alternate embodiment of the dispenser of this invention employing a dispenser cap and applicator having an oval shape with the dispenser cap in a closed position.

FIG. 12B is a plan view of the dispenser cap shown in FIG. 12A in an opened position.

FIG. 13A is a cross-sectional view of another embodiment of this invention showing an applicator employing bristles for scrubbing a surface.

FIG. 13B is a plan view taken along line 13B-13B of FIG. 13A.

FIG. 13C is a side view of an adhesive backed, replaceable bristle applicator.

FIG. 14A is a perspective view of one embodiment of the dispenser of this invention where the container is made using the blow mold process.

FIG. 14B is cross-sectional view taken along line 14B-14B of FIG. 14A.

FIG. 14C is a cross-sectional view of the dispenser of this invention shown in FIGS. 14A and 14B with its cover and base member components all attached.

FIG. 15A is a cross-sectional view of an embodiment of this invention employing an applicator with a smooth, porous surface that is suited to dispense a deodorant or other liquid.

FIG. 15B is a perspective view of the applicator used in the embodiment shown in FIG. 15A.

FIG. 15C a cross-sectional view similar to that of FIG. 15A showing pins of a top enclosure inserted into orifices in the applicator.

FIG. 16 is a side view with sections broken away of an embodiment of this invention showing a top enclosure holding extra, replaceable applicators.

FIGS. 17A through 17D illustrate the paint merchandising method of this invention, where:

FIG. 17A is a depiction of a consumer purchasing from a salesperson one or more of the dispensers of this invention containing paint.

FIG. 17B is a depiction of a consumer applying the paint to the surface of an object using a dispenser of this invention.

FIG. 17C is a depiction of a consumer calling a salesperson to communicate which color the consumer has determined works the best on the selected surface and ordering additional quantities of the desired paint color.

FIG. 17D is a depiction of a bar code on a dispenser of this invention being scanned facilitating ordering a larger quantity of the desired color of paint.

### DETAILED DESCRIPTION OF SOME EMBODIMENTS OF THIS INVENTION

General

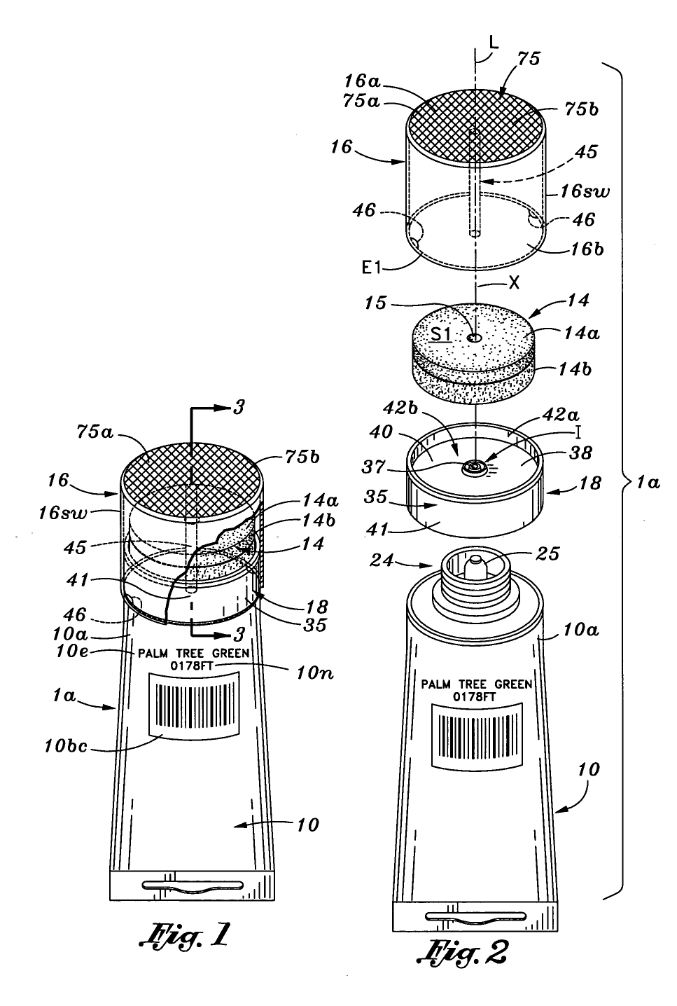

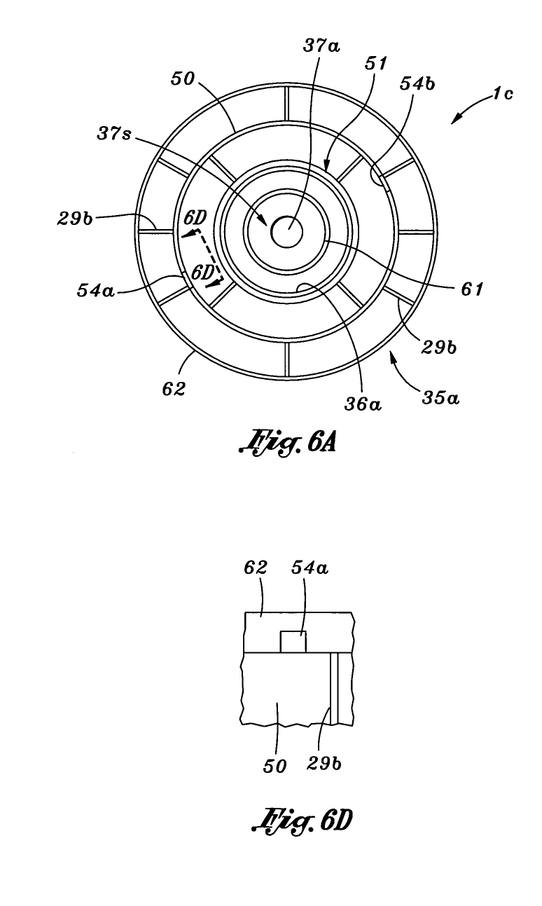

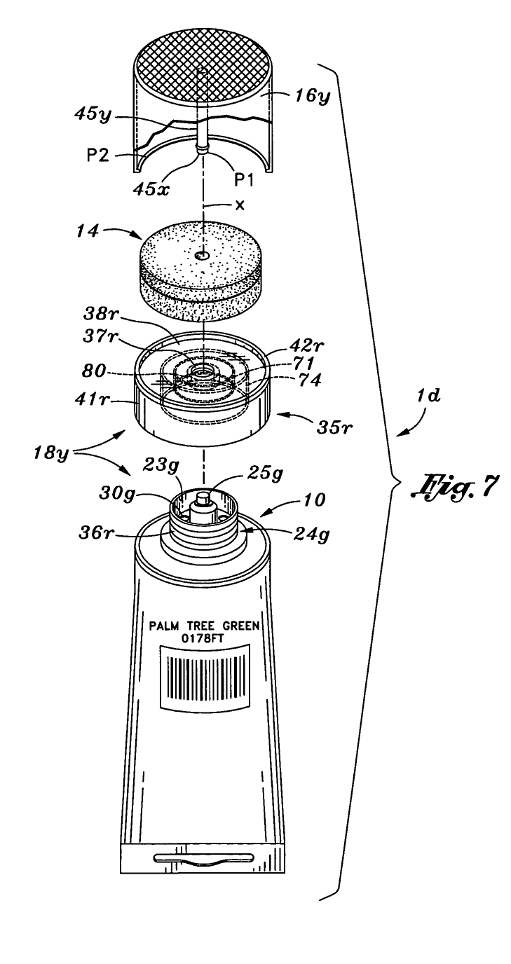

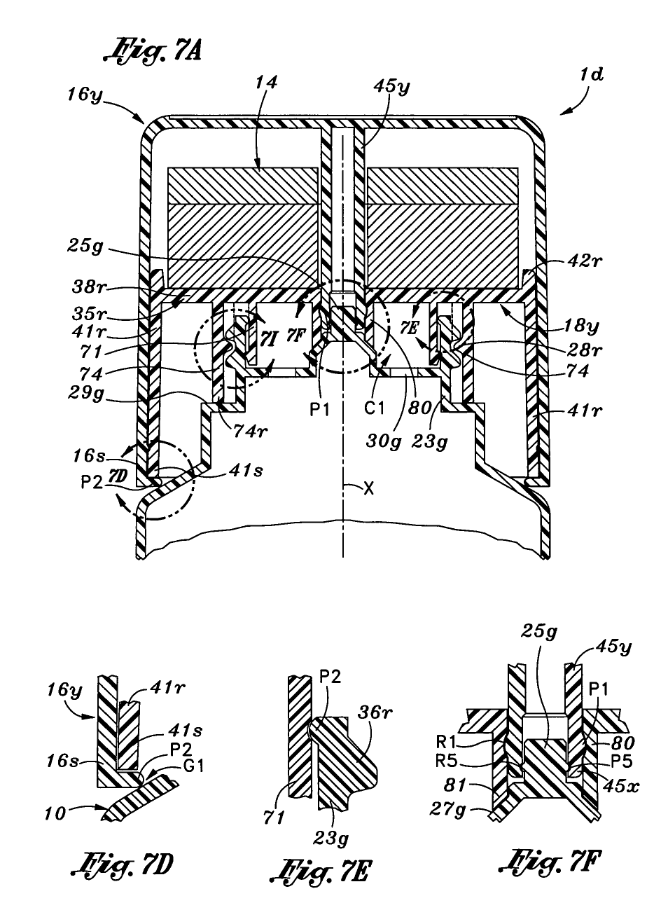

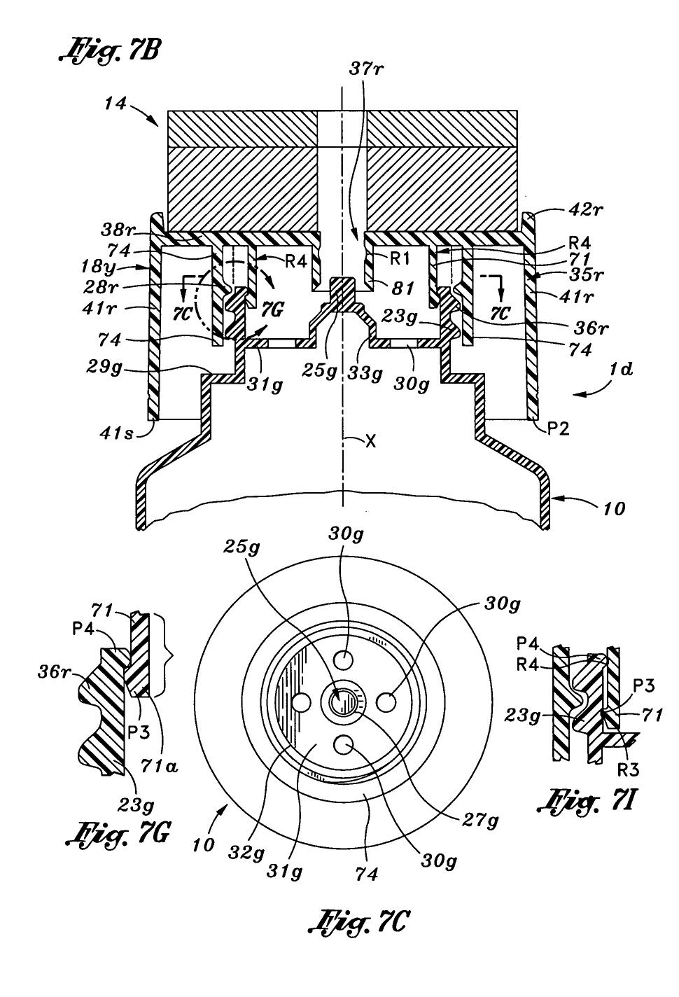

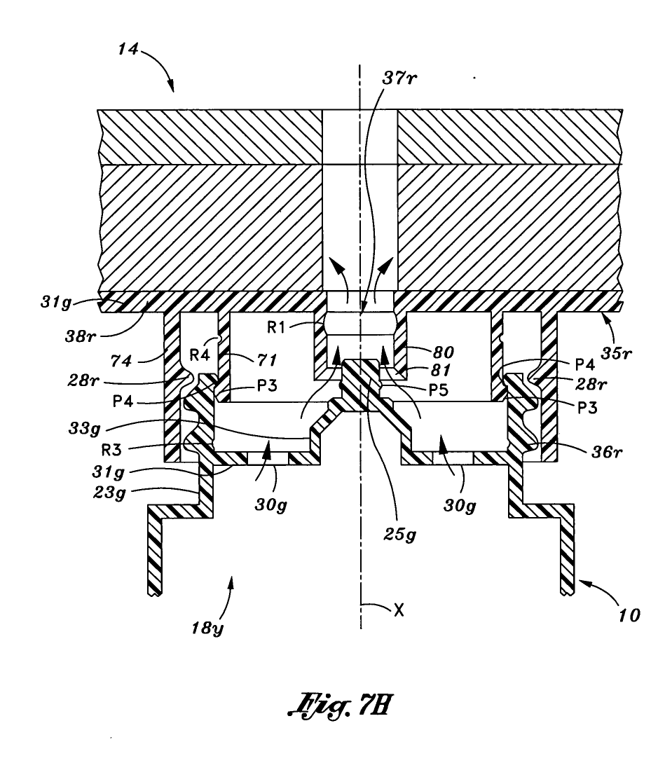

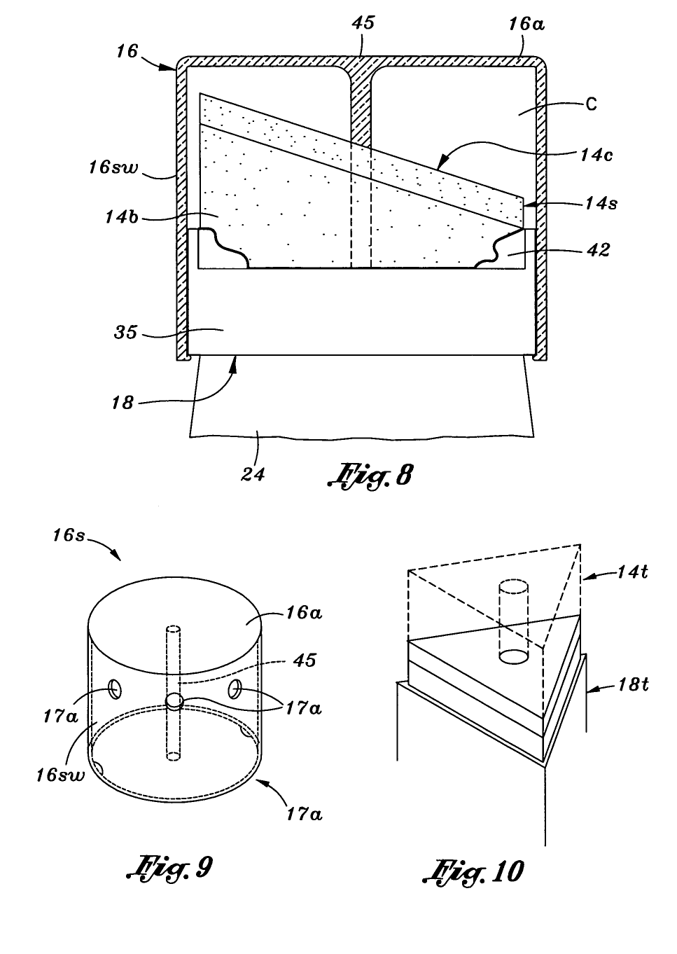

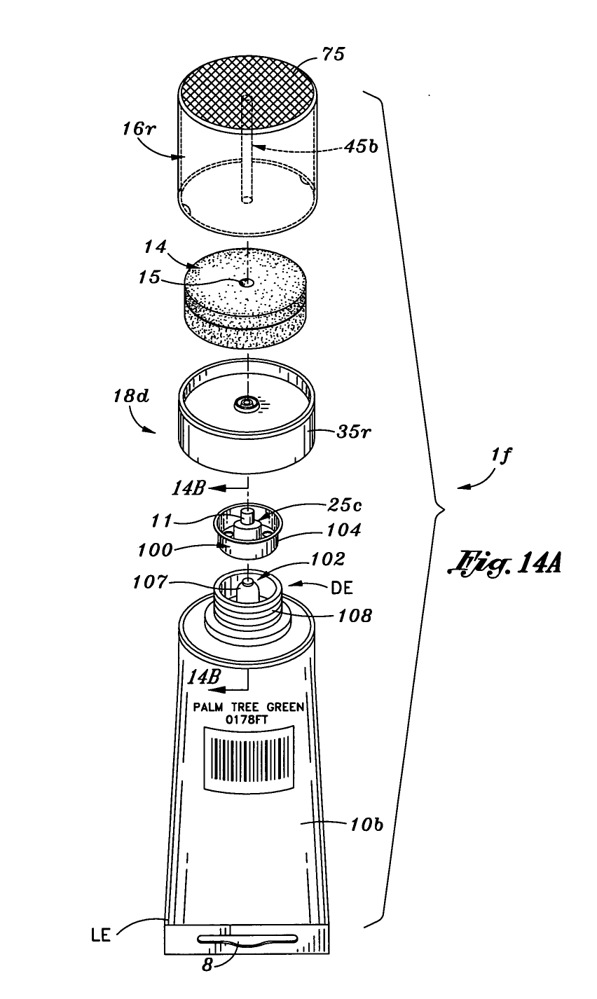

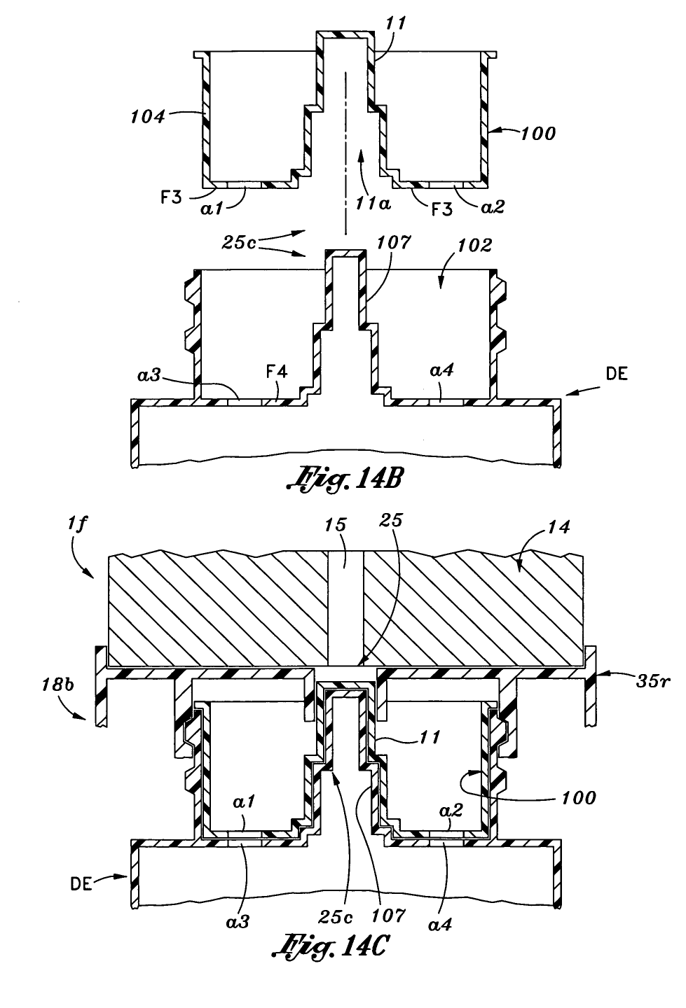

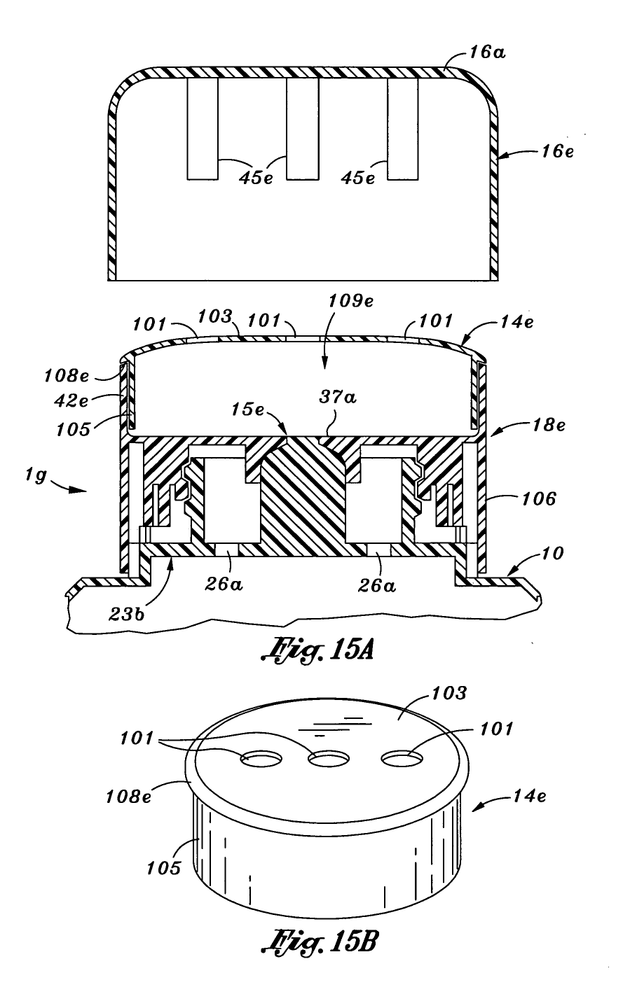

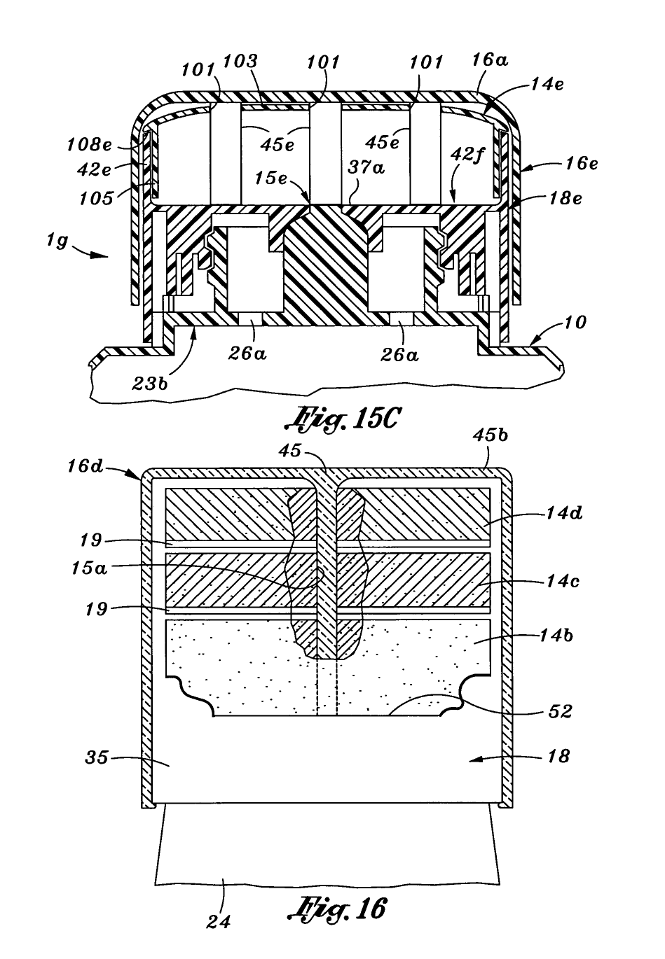

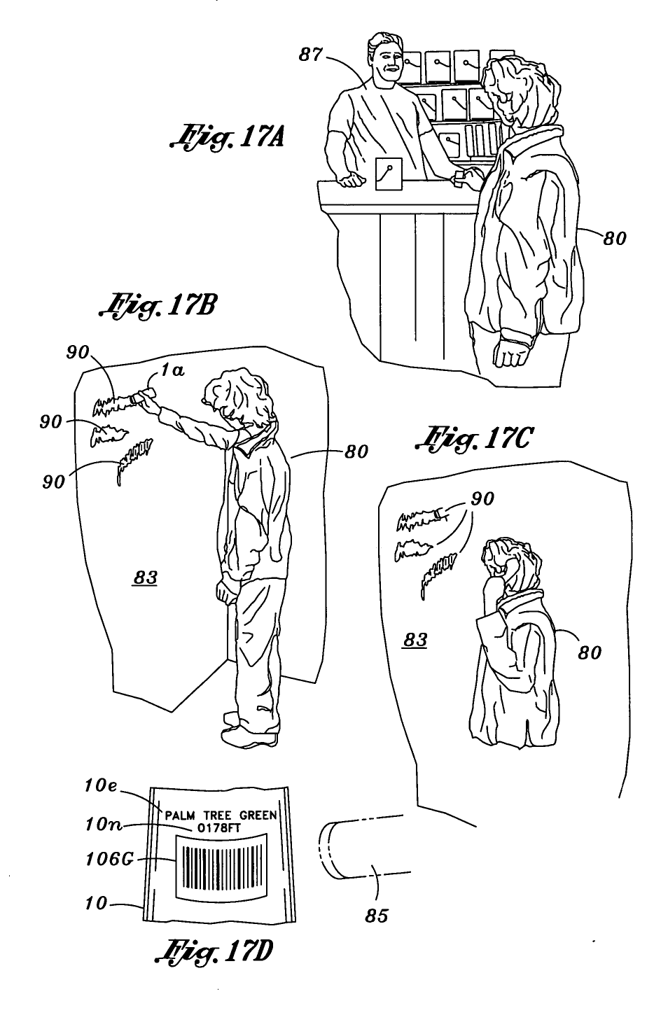

FIGS. 1 through 4 depict one embodiment of the dispenser of this invention, the dispenser 1a; FIG. 4A depicts another embodiment of the dispenser of this invention, the dispenser 1b; FIGS. 6A through 6D depict a conventional cap modified to form one more embodiment of the dispenser of this invention, the dispenser 1c; FIGS. 7 through 7I depict an embodiment employing a dispenser cap with multiple seal points, the dispenser 1d; FIG. 8 illustrates an embodiment employing an applicator having a slanted top surface; FIG. 9 shows an embodiment employing a top enclosure with a plurality of ventilation holes; FIGS. 10 through 12B depict alternate embodiments employing dispenser caps of different shapes; FIGS. 13A through 13C illustrate an embodiment using an applicator with bristles, the dispenser 1e; FIGS. 14A through 14C depict a blow molded container with a hard plastic insert at its dispensing end, the dispenser If; FIGS. 15A through 15C depict an embodiment having a rigid, dome shaped applicator adapted to be used to apply deodorant to a human's underarm, the dispenser 1g; FIG. 16 illustrates an embodiment where a top enclosure holds extra, replaceable applicators; and FIGS. 17A through 17D depict the merchandising of paint of different colors in accordance with the method of this invention.

The different embodiments of the dispenser of this invention include (i) a container 10 holding a fluid material, typically a liquid or gel, (ii) a dispenser cap (different types may be employed as discussed subsequently) operatively connected to the container 10, (iii) an applicator (different types may be employed as discussed subsequently) operatively connected to the dispenser cap, and (iv) a manually removable top enclosure (different types may be employed as discussed subsequently) covering the applicator and having an internal, a longitudinally extending enclosure pin or pins that engage the applicator to provide an additional seal. The dispenser cap may be detachably connected to the container 10 or it may be integral with the container 10 and not be detached without damaging the container. The container 10 may be made of a flexible or malleable material such as a thin plastic, enabling the container to be squeezed to expel the contents of the container. The container 10 may be made using conventional techniques, and may, for example, be extruded. Alternately, it may be blow molded as depicted in FIGS. 14A through 14C. The dispenser cap and top enclosure may each be made of a rigid material such as a hard plastic and formed by a conventional molding process.

FIGS. 1 Through 5, 8, and 9

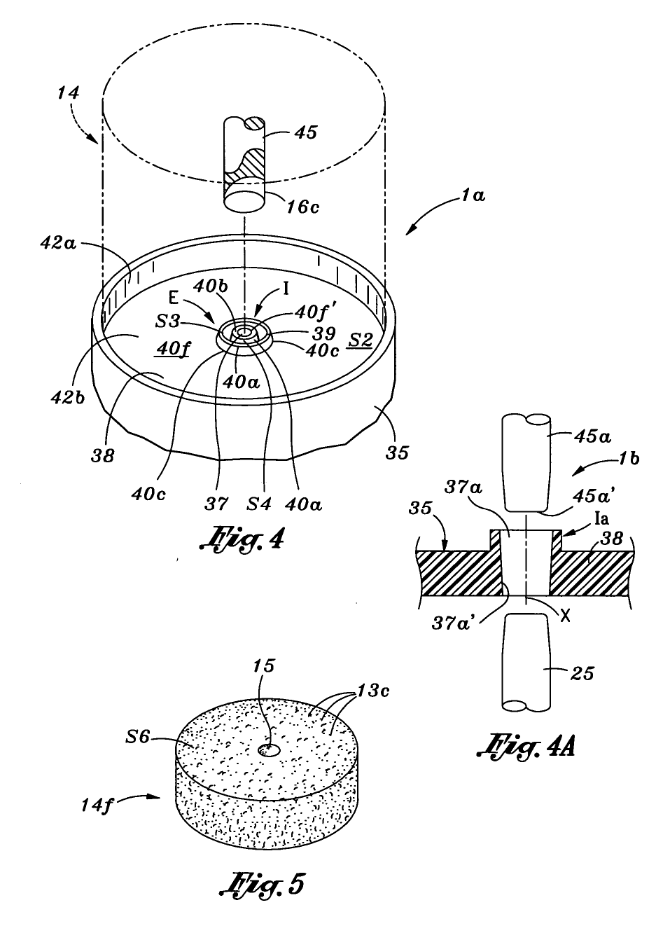

Referring to FIGS. 1 through 4, the dispenser 1a includes the container 10, a substantially cylindrically shaped dispenser cap 18, attached to an upper end 10a of the container 10, and a top enclosure 16. The dispenser cap 18 comprises two main components: a substantially cylindrical shaped base member 24 and a substantially cylindrical shaped cover member 35. Attached to the cover member 35 is an applicator 14. The applicator 14 has an elongated opening forming a passageway 15 that longitudinally extends along a central reference line, axis X. Typically, the base member 24 and cover member 35 are molded from a plastic such as, for example, polyethylene. In this embodiment the base member 24 is integral with the container 10 as best shown depicted in FIGS. 3 and 3A.

FIG. 3 shows the dispenser cap 18 in a closed position and FIG. 3A shows the dispenser cap 18 in an open position with the top enclosure 16 removed. The cover member 35 overlies the base member 24 and both these members are along the axis X and mounted to rotate relative to each other. Specifically, the base member 24 and the cover member 35 include a matching set of threads 28 and 36, respectively. This thread arrangement allows the cover member 35 to be twisted manually with respect to the base member 24, rotating about the axis X. This rotation raises or lowers the cover member 35 with respect to the base member 24 to move back and forth between the closed position and open position.

The base member 24 includes a central base plug 25 along the axis X. The base plug 25 is a short, substantially conical protrusion that extends outward from the base member 24, substantially perpendicular to an exterior surface 24x (FIG. 3A) of a top wall 30 of the base member 24. From where the base plug 25 joins the top wall 30, the base plug tapers upward and inward to create a base plug that is wider at its lower portion 25a than the tip 25b of the base plug 25. Adjacent to the base plug 25 are one or more holes 30a in the top wall 30 that, when the dispenser cap 18 is in an open position (FIG. 3A), allows fluid material in the container 10 to escape, for example, upon squeezing the container. In this embodiment, the base member's external threads 28 are located on the outer wall 24a of the base member 24, and this outer wall 24a is integral with and forms a wall of the container 10. These walls transition into each other in such a manner that there is no clear delineation between where the base member 24 stops and a container wall 24a begins.

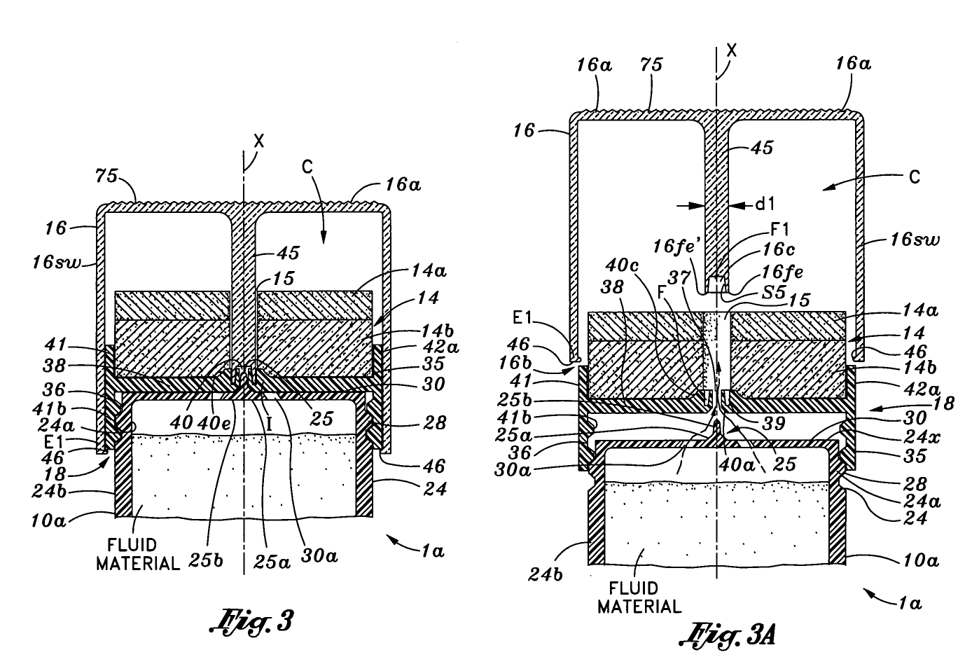

The cover member 35 includes a substantially circular top wall 38 and a cylindrical cover sidewall 41 along an outer edge of the top wall 38. The cover sidewall 41 is oriented substantially perpendicular to the top wall 38 and extends above and below the top wall 38, forming the perimeter of the cover member 35. The cover sidewall 41 has a smooth exterior surface and is integral with top wall 38. The internal surface of the portion 41b of the cover sidewall 41 that extends below the cover top wall 38 includes the threads 36. The matching threads 36 and 28 operatively connect the cover member 35 and the base member 24 in a manner that allows the cover member 35 to move only in a circular twisting manner, clockwise or counterclockwise. The portion of the cover sidewall 41 that extends above the top wall 38 forms a cover lip 42a to create a substantially cylindrical receptacle portion 42b (FIG. 2) in which the applicator 14 is seated. The diameter of the receptacle portion 42b is substantially equal to the diameter of the applicator 14, so the lower portion of the applicator 14 fits snugly within this receptacle portion. The lip 42a extends above the cover top wall 38 to assist in holding the applicator 14 in place within the receptacle portion 42b, thus helping to keep the applicator 14 securely attached to the cover top wall 38 when lateral forces are applied thereto during use.

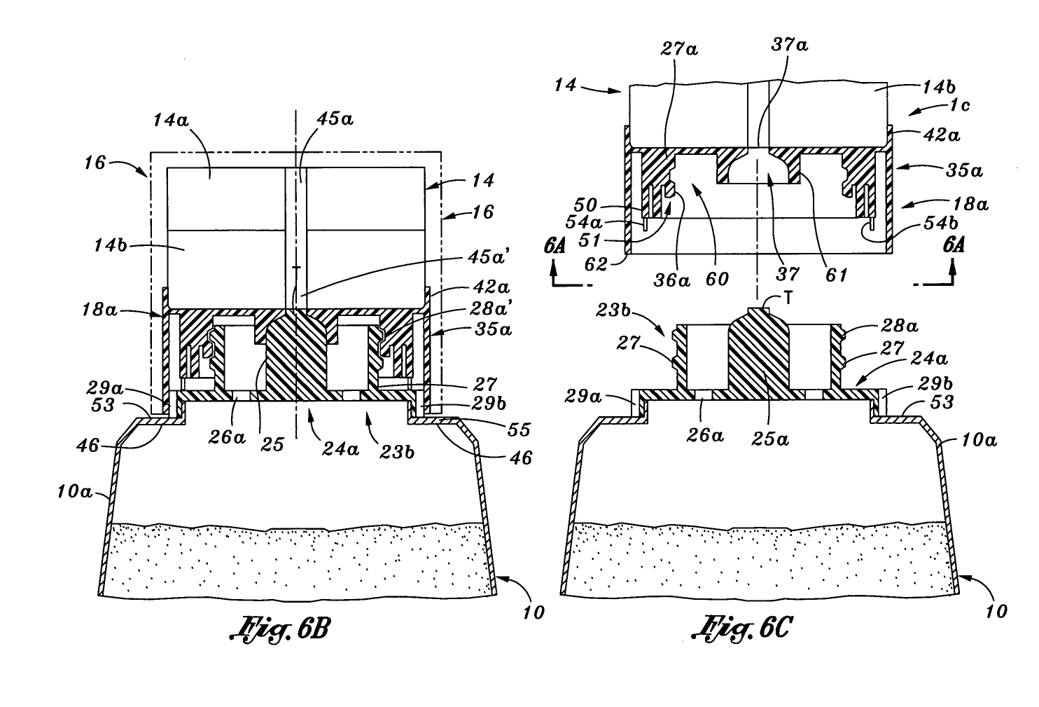

In the embodiment shown in FIGS. 1 through 4, the applicator 14 has a cylindrical shape and is made of two different resilient materials, for example, a low-density sponge forming the bottom layer 14b and a high-density sponge forming the top layer 14a. In the embodiment shown in FIG. 5, an applicator 14f is used in which the inner material is a soft sponge-like material and its outer surface S6 comprises of a multitude of small diameter, short fibers 13c; this outer surface S6 is also known as a flocked surface. In the embodiment shown in FIG. 8, an applicator 14s, similar to the applicator 14, is illustrated, but this applicator 14s has a slanted top surface 14c.

The applicator may be fixedly attached to the cover member 35, for example as depicted in FIGS. 1 through 4, or, as depicted in FIG. 16, it may be mounted so that it may be removed, discarded, and replaced with a fresh applicator. In the embodiment illustrated in FIGS. 1 through 4, the applicator 14 is glued to the top outer surface S2 of the cover top wall 38 to fixedly attach it to the top outer surface S2 of the cover top wall 38. The lower portion of the applicator 14 fills substantially the entire receptacle portion 42b in the cover top wall 38. The longitudinal passageway 15 of the applicator 14 has a diameter that is equal to, or slightly greater than the diameter of the external surface of the enclosure pin 45. With the top enclosure 16 covering the dispenser cap 18 and the dispenser cap 18 closed (FIG. 3), the pin 45 passes through the applicator passageway 15 and mates with an annular channel 39 in the cover member 38 to aid in sealing the container 10 as discussed subsequently in greater detail. When the dispenser cap 18 is opened (FIG. 3A) and the top enclosure 16 detached from the dispenser cap 18, the pin 45 is withdrawn from the passageway 15, enabling the consumer to dispense the fluid material from the container 10.

As best depicted in FIGS. 3A and 4, the top wall 38 is mostly of uniform thickness except for a raised central island I on the exterior surface S2 of this top wall 38. An opening 37 (FIG. 3A) in this island I extends through the center of the cover top wall 38 and lies along the axis X. The opening 37 is sized and shaped such that the base plug 25 fits snugly within it, leaving no gaps when the dispenser cap 18 is closed (FIG. 3). Specifically, the diameter of the cover opening 37 initially remains constant as it projects inward towards the base member 24 but then increases, expanding outward to accommodate the tapered lower portion 25a of the base plug 25 upon closure of the dispenser cap 18 (FIG. 3). Additionally the annular channel 39 is in the island I and is concentric with the opening 37.

As best shown in FIGS. 4 and 3A, the combination of the opening 37 and concentric channel 39 forms in the island I a pair of concentric rings: an outer ring 40a and inner ring 40b. The exterior surface of the outer ring 40a tapers outward away from the opening 37 until its lower outer edge 40c is flush with the surface S2 of cover top wall 38. The ring 40a extends upward from this edge 40c to terminate in a substantially flat surface 40f. The inner ring 40b also terminates in a substantially a flat surface 40f′. The flat surfaces 40f and 40f′ are substantially coplanar and substantially parallel to the surface S2 of the cover top wall 38. The interior surface S3 of the outer ring 40a is substantially perpendicular to the flat surface 40f and the exterior surface S4 of the inner ring 40b is tapered slightly outward toward the surface S3 of the outer ring 40a such that the entrance E to the cover channel 39 is slightly wider than its floor F. This creates a channel cross-sectional configuration which mates with a uniquely shaped free end 16fe (FIG. 3A) of the enclosure pin 45 when the top enclosure 16 is attached as shown in FIGS. 1 and 3.

The top enclosure may be, for example, a solid top enclosure 16 (FIG. 2) or include a plurality of ventilation holes 17a (FIG. 9). As best shown in FIGS. 2, 3 and 3A, the top enclosure 16 is a substantially cylindrical structure having a circular top wall 16a closing one end of the top enclosure 16. An annular sidewall 16sw extends outward from the top wall 16a substantially perpendicular thereto, terminating in an open-end 16b opposite the top wall. Typically, the top enclosure 16 is rigid, for example being molded from a hard plastic; and it may be opaque or, to enable a consumer to see the applicator 14, it may be translucent or transparent. The enclosure pin 45 discussed above is integral with the top wall 16a and extends into an internal cavity C in the top enclosure 16 substantially perpendicular to the top wall 16a along a longitudinal center line L (FIG. 2), which is coextensive with the axis X when the top enclosure 16 is attached to the dispenser cap 18 as shown in FIG. 1. There is a pair of opposed prongs 46 at a bottom edge E1 of the open-end 16b. As shown in FIG. 3, the prongs 46 protrude inward a short distance toward the centerline L just enough to secure the top enclosure 16 in place over the dispenser cap 18. The prongs 46 hold the top enclosure 16 snugly in place, but are sufficiently flexible to allow the consumer to remove the top enclosure by applying an adequate amount of force. Alternately, instead of a plurality of individual discrete prongs 46, the prong may be an annular ring that projects, approximately the same length as the prongs 46, toward the center of the top enclosure 16 from the inside surface of the top enclosure 16. The annular ring is identical in function to the prongs 46

As depicted in FIG. 1, the exterior of the enclosure top wall 16a may have an abrasive surface 75 that allows the consumer to smooth potentially rough areas on the surface they wish to cover with the fluid material. The abrasive surface 75 may be created by bonding with adhesive an abrasive material such as sandpaper to the exterior of the top wall 16a, or it may be integral therewith, for example formed during molding of the top enclosure 16. The abrasive surface 75 depicted in FIG. 1 is one that is integral with the outer surface of the top wall 16a and formed during molding. This abrasive surface 75 comprises one set 75a (FIG. 1) of multiple parallel shallow grooves that are at a right angle to another set 75b of multiple parallel shallow groves. This crisscrossing of the two sets 75a and 75b of parallel groves creates a plurality of shallow pockets, thus creating an abrasive surface 75. In an alternate embodiment shown in FIG. 9, a top enclosure 17 does not have an abrasive surface but includes a plurality of ventilation holes 17a in the sidewall 16sw to allow air to access and dry the applicator 14. These ventilation holes 17a do not adversely affect sealing of the container 10 as discussed subsequently.

In the embodiment illustrated in FIGS. 1 through 4, the enclosure pin 45 is an elongated cylindrical member having a free end 16fe (FIG. 3B) shaped to fit snugly within the channel 39 of the cover member 35. More specifically, as best shown in FIGS. 3A and 3B, this free end 16fe terminates in a flat surface edge 16fe′ and includes a cavity 16c having an inwardly tapering internal surface S5 and a depth that essentially equals the depth of the channel 39. The cavity 16c is formed by an annular wall having the internal surface S5 and terminating at a ceiling F1. The enclosure pin 45 has an outside diameter dl that is equal to, or just slightly less than, the diameter of the annular interior surface S3 of the outer ring 40a. The depth of the cavity 16c is sufficient to allow the free end 16fe to fit all the way to the floor F of the channel 39 when the top enclosure 16 is attached to the cap 18. The internal surface S5 progressively decreases the diameter of the hollow cavity 16c as it extends along the length of the enclosure pin 45, substantially matching the configuration of the channel 39 and being equal to, or just slightly greater than, the changing width of the channel 39. In other words, the cross-sectional configuration of the free end 16fe is complementary to the cross-sectional configuration of the channel 39. Thus, upon attaching the top enclosure 16 to the cap 18, there is a male-female mating connection, with the flat surface 40f′ of the inner ring 40b abutting the ceiling F1 of the cavity 16c and flat surface edge 16fe′ abutting the floor F of the channel 39 and the annular wall fitting snugly within the channel.

In an alternate embodiment shown in FIG. 4A, the top enclosure 16 employs a solid enclosure pin 45a and the cover member 35 employs a central island Ia with a single, substantially cylindrical opening 37a extending through the cover member along the axis X. When the top enclosure 16 is attached to the dispenser cap 18, the end 45a′ of the pin 45a is pushed into the opening 37a. The end 45a′ of the pin 45a and the internal side 37a′ of the opening 37a may be tapered slightly. In both embodiments shown in FIGS. 3A and 4A, the pins 45 and 45a are sufficiently long to penetrate a sufficient distance into their respective opening 37 and 37a to seal, at least partially, these openings. Also in both these embodiments, the annular sidewall 16sw is longer than the pins 45 and 45a, so that, when the top enclosure 16 is attached to the dispenser cap 18 as shown in FIG. 3, the prongs 46 grip the dispenser cap 18, for example, along a bottom edge of the portion 41b of the cover sidewall 41. Alternately, these prongs 46 may grip the base member 24 or another part of the container 10 when the top enclosure 16 is attached to the dispenser cap 18, or an annular projection and recess may be used as discussed subsequently in connection with FIGS. 7A through 7 I.

When the fluid material is to be dispensed from the container 10, the top enclosure 16 is detached and the cover member 35 is twisted to break the seal between the cover member 35 and the base member 24 (FIG. 3A). Thus, upon squeezing the container 10, the fluid material flows through the holes 30a and then through the opening 37 and finally into the passageway 15 and the applicator 14. The sponge applicator 14 absorbs this material. To release this fluid material from the sponge applicator 14, the applicator is compressed inward toward the cover top wall 38 by pressing its exterior top surface S1 against an object's surface, releasing the fluid material retained in the pores of the applicator 14 and applying it to the object's surface. The height of the cover lip 42a is such that, when the applicator 14 is compressed, this lip does not touch an object's surface. In other words, the length of the applicator is substantially greater than the height of the cover lip 42a, so that a top surface S1 of a compressed applicator is still above the cover lip 42a.

After dispensing the fluid material from the container 10, the cover member 35 is rotated counter-clockwise as viewed in FIGS. 1 and 3 as far as it can go, lowering the cover member 35 as low as it can go, thus putting the dispenser cap 18 in the closed sealing the container 10 by the mating of the matching male base plug 25 and female cover opening 37. The sealing of container 10 is further reinforced, when the top enclosure 16 is snapped into place over the dispenser cap 18. The reinforcement occurs by mating the cover member channel 39 with the free end 16fe of the enclosure pin 45.

FIGS. 6A Through 6D

Depicted in FIGS. 6A through 6D is another embodiment of the present invention using a conventional dispenser cap 18a modified to accommodate an applicator 14 and a top enclosure 16 (shown in phantom line in FIG. 6B) in accordance with this invention. In this embodiment, a base member 23b of the cap 18a is bonded to the upper end 10a of the container 10 and a cover member 35a is mounted to rotate with respect to the base member. This base member 23b has the same basic components as the base member 24 depicted in FIGS. 3 and 3A (thought shaped differently) and it also has a few additional components that provide an audible signal upon opening and closing the cap 18a. Moreover, the assembly of the cover member 35a and attached applicator 14 may disconnected from the base member 23b as shown in FIG. 6C. Upon attachment of the base member 23b and cover member 35a, threads 28a on an outside surface of a cylindrical wall 27 of the base member 23b engage threads 36a on the inside surface of a cylindrical wall 27a forming a cavity 60 in the cover member 35a. The base member 23b includes holes 26a, and the cover member 35a includes a cover opening 37a, so that, when opened, fluid material flows through the dispenser cap 18a and into the applicator 14. When the dispenser cap 18a is closed, the opening 37a is sealed by a base plug 25a being pushed into a domed pocket 37s in which the cover opening 37a is centered. A tip T of the base plug 25a is equal in diameter to the cover opening 37a and lays flush with the top surface of the cover member 35a when sealed as shown in FIG. 6B. Upon placing the top enclosure 16a over the closed dispenser cap 18a, the end 45a′ of a solid enclosure pin 45a abuts the tip T of the base plug 25a and does not extend into the opening 37a, but the end 45a′ of the pin 45a (FIG. 6B) is pressed firmly against the tip T of the base plug 25a.

As best illustrated in FIG. 6A, the cover member 35a includes a series of concentric annular walls 62, 50, 51 and 61. The wall 61 partially forms the pocket 37s. A stop mechanism is employed to limit the rotation of the cover member 35a. Nevertheless, with sufficient force, the consumer may override this stop mechanism and detach the cover member as shown in FIG. 6C. This stop mechanism includes upward projecting raised protrusions or stop members 29a and 29b on the base member 23b and a pair of clickers 54a and 54b located along an edge of the ring 50 the cover member 35a. The stop members 29a and 29b may be triangular in shape and are located on top of a flat horizontal portion 53 of the base member 23b. The stop members 29a and 29b are oriented such that two of its angled sides comprise a raised protrusion face tangentially to the circumference of the base member 23b and they are high enough so they make contact with the clickers 54a and 54a when aligned therewith.

The stop members 29a and 29b interact with the clickers 54a and 54b to provide a tactile and audible signal to the consumer that continued rotation will either detach the cover member 35a or attached the cover member to the base member 23b in a sealed relationship. The clickers 54a and 54b are low enough to pass over the raised protrusions 29a and 29b with continued rotation. When the cover member 35a is either being attached or detached, one of the clickers, clicker 54a or 54b depending on the rotational direction, brushes against the raised protrusion 29a and the consumer can feel this engagement as he or she is rotating the cover member 35a. As the consumer continues twisting, a clicker 54a or 54b, as the case may be, is bent and then released to make a “click noise” as it passes over a raised protrusion and snaps back into place. This “click noise” is an audible signal indicating to the consumer that the cover member 35a is securely attached to or detached from the base member 23b.

FIGS. 7 Through 7I

The embodiment of the dispenser of this invention depicted in FIGS. 7 through 7I includes multiple barriers or seals that inhibit or prevent leakage, for example, mating annular elements. As shown in FIGS. 7 and 7A, this dispenser includes a cap 18y covered by a top enclosure 16y similar to the top enclosures used in the embodiments discussed above. The main difference is that the top enclosure 16y includes a central, hollow, cylindrical pin 45y with an outwardly extending annular projection P1 (FIG. 7F) on its exterior surface near an open distal end 45x of the pin. This projection P1 extends into a mating annular recess R1 on the inside surface of a cylindrical wall 80 of the cap 18y. The longitudinal axis of the pin 45y is co-extensive with the central, longitudinal centerline or axis X of the dispenser of this embodiment.

The cap 18y includes a cover member 35r that is detachably connected to a base member 24g by the matching sets of threads 28r and 36r. The threads 28r are on an inside surface of a cylindrical wall 74 of the cover member 35r and the threads 36r are on an outside surface of a cylindrical wall 23g of the base member 24g. The cover member 35r can be rotated back and forth between a normally closed position (FIG. 7A) and an open position (FIG. 7B). The base member 24g may be connected to the flexible container 10 by a conventional bonding technique and is immovable. The wall 74 is of a length and the threads 28r are configured so that an adequate travel distance is provided for raising and lowering the cover member 38r to enable the cover member 35r and the base member 24g to interact and seal as subsequently discussed.

The cover member 35r has a generally cylindrical configuration and includes a circular top wall 38r with a central, circular opening 37r and a cylindrical outer sidewall 41r along an outer edge of the top wall 38r. The outer sidewall 41r is substantially perpendicular to the top wall 38r and has an upper portion that extends above the top wall to form a lip 42r along the perimeter of the top wall 38r that surrounds a lower portion of the sponge applicator 14. The cylindrical wall 74 and two other cylindrical walls 71 and 80 extend down from the inside surface of the top wall 38r. All the walls 41r, 71, 74, and 80 are concentric with the axis X. The sidewall 41r is the longest of these walls and the wall 80 the shortest. As shown in FIGS. 7A and 7D, when the cap 18y is in the closed position, a free end 41s at a lower portion of the sidewall 41r of the cover member 35r is in very close proximity to the container 10 to provide a narrow gap G1 (FIG. 7D) between this free end 41s and the container 10. A lower end 16s of the top enclosure 16y terminates in an annular projection P2 that extends inward towards the axis X and fits into the gap G1. The projection P2 and the free end 41s interact to provide a catch mechanism for holding the top enclosure 16y on the cap 18y until the consumer pulls the top enclosure 16y off the cap 18y.

The cylindrical wall 80 of the cover member 35r has an inside diameter that is essentially the same as the diameter of the opening 37r. The outside surface of the wall 80 is smooth. As best shown in FIG. 7H and discussed subsequently in greater detail, the inside surface of the wall 80 has therein an annular recess R1 that assists in providing a seal when the cap 18y is in the closed position and enclosure 16y is secured in place shown in FIG. 7A. As best depicted in FIG. 7F, the wall 80 is sufficiently long that, when the cover member 35r is in the closed position, a beveled end 81 of the wall 80 engages a truncated conical wall 27g surrounding a central, cylindrical plug member 25g in the base member 24g. A leading edge of the beveled end 81 is angled so that it matches the slope of the tapered surface of the wall 27g. In the closed position, this beveled end 81 presses firmly against the wall 27g, thereby creating a seal or barrier that prevents or inhibits leakage.

The cylindrical wall 71 is between the walls 74r and 80 and is longer than the wall 80 and shorter than the wall 74. As best shown in FIG. 7G, a free end 71a of the wall 71 includes an outward extending annular projection P3 that interacts with an outward extending annular projection P4 in a cylindrical wall 23g of the base member 24g. (The wall 23g is also concentric with the axis X.) The projections P3 and P4 face each other and their interaction provides a stop mechanism that prevents the consumer from accidentally over rotating the cover member 35r and removing it inadvertently. The diameters of the walls 71 and 23g are such that the outer most edge of each projection P3 and P4 applies pressure against surface of the opposite wall. As best illustrated in FIG. 7I, when in the closed position shown in FIG. 7B, the annular projection P3 mates with an annular recess R3 in the inside surface of the wall 23g, fitting snug within this annular recess R3. The annular projection P4 mates with an annular recess R4 in the outside surface of the wall 71, fitting snug within this annular recess R4. This provides a dual seal that prevents or inhibits leakage between the walls. Additionally as depicted in FIG. 7I, when the cap 18 is in the closed position the wall 71 is primarily sealed by the projection P3 pressing firmly into the annular recess R3 and the projection P4 pressing firmly into the annular recess R4.

When the cover member 35r is rotated counter-clockwise as viewed in FIG. 7C, it moves from the completely closed position towards the completely open position shown in FIG. 7B. The threaded surfaces 28r and 36r of the cover member 35r and the base member 24g cause the projection P3 to slide along a spiral path upward along the smooth inside surface of the wall 23g until it makes contact with the projection P4 as shown in FIG. 7G. At this point the unimpeded twisting motion will be stopped. When the projections P3 and P4 initially engage upon rotating the cap 18y into the open position shown in FIG. 7B, the consumer feels a resistance against any further rotation. Nevertheless, the consumer can overpower the stopping action of the initially engaged projections P3 and P4 by applying additional force to detach the cover member 35r from the base member 24g.

As best shown in FIGS. 7C and 7H, the base member 24g includes a top wall 31g with four holes 30g surrounding the plug member 25g. The axis X is substantially perpendicular the top wall 31g and intersects the center of the top wall 31g and the center of the plug member 25g. A short cylindrical sidewall 33g that is substantially perpendicular to the top wall 31g connects the angled wall 27g to this top wall 31g. The plug member 25g extends outward from the top wall 31g towards the opening 37r in the wall 38r of the cover member 35r. In the closed position (FIG. 7A) the plug member 25g is inserted into the opening 37r to block it and prevent fluid material from escaping through this opening 37r. As best shown in FIGS. 7A and 7F, the plug member 25g fits within the opening 37r when the dispenser is in the closed position (FIG. 7A), with there be just enough gap between the top of the plug 25g and the opening 37r to allow for the pin 45y to fit therein. In the closed position, an annular projection P5 on the exterior surface of the sidewall of the plug member 25g mates with an annular recess R5 near the open distal end 45x of the hollow pin 45y, fitting snugly within the annular recess R5.

In this embodiment the holes 30g are not sealed. Rather, when the dispenser cap 18y is in the closed position (FIG. 7A), the fluid material within the container 10 can fill a cavity C1 (FIG. 7A) but can escape no further. This is because the cavity C1 is sealed on all sides (except the holes 30g which allow the contents to pass between the container 10 and cavity C1). The cavity C1 is sealed around its outer circumference by the cylindrical walls 71 and 23g (the gap between these walls is also sealed by the protrusions P3 and P4 discussed above). The diameter of the outer circumference created by walls 71 and 23g is sufficient so that the holes 30g are within its perimeter. This seal is effective whether the cap 18y is in the open or closed position. Additionally in the closed position (FIG. 7A), this cavity C1 is sealed off from cover opening 37r by the seal between wall 80 and the wall 27g of the base plug member 25g as follows: As depicted in FIG. 7F, the wall 80 is primarily sealed by the plug member 25g being pushed into the opening 37r and the projection P5 pressing firmly into the annular recess R5 of the enclosure 16y. As illustrated in FIG. 7A, the wall 74 terminates in an end 74r that abuts a flat ledge 29g of the base member 24g when the cap 18y is in the closed position to provide a barrier that further inhibits any leakage.

The dispenser shown in FIGS. 7 through 7I functions in a manner similar to the embodiments discussed above but has the improved sealing features discussed above. Initially the top enclosure 16y covers the cap 18y and the pin 45y extends into the opening 37r with the plug member 25g inserted into the open distal end 45x of the pin. The cap 18y is in the closed position initially (FIG. 7A) and a tight seal is formed by, among other things, the annular projection P1 fitting snug within the annular recess R1, the annular projection P3 fitting snug within the annular recess R3, the annular projection P4 fitting snug within the annular recess R4, and the annular projection P5 fitting snuggly within the annular recess R5. With the enclosure 16y attached to the closed cap 18y if the enclosure 16y is rotated by the consumer, the projection P2 will freely turn within the gap G1 while the cover member 35r will not turn relative to the base member. Thus, the consumer cannot accidentally twist the enclosure 16y to open the cap 18y when he or she is simply attempting to remove the enclosure and not open the cap. Thus, as discussed above, multiple barriers or seals are provided that prevent or inhibit leakage of fluid material from within the container 10 when the cap 18y is closed.

FIGS. 10 Through 12

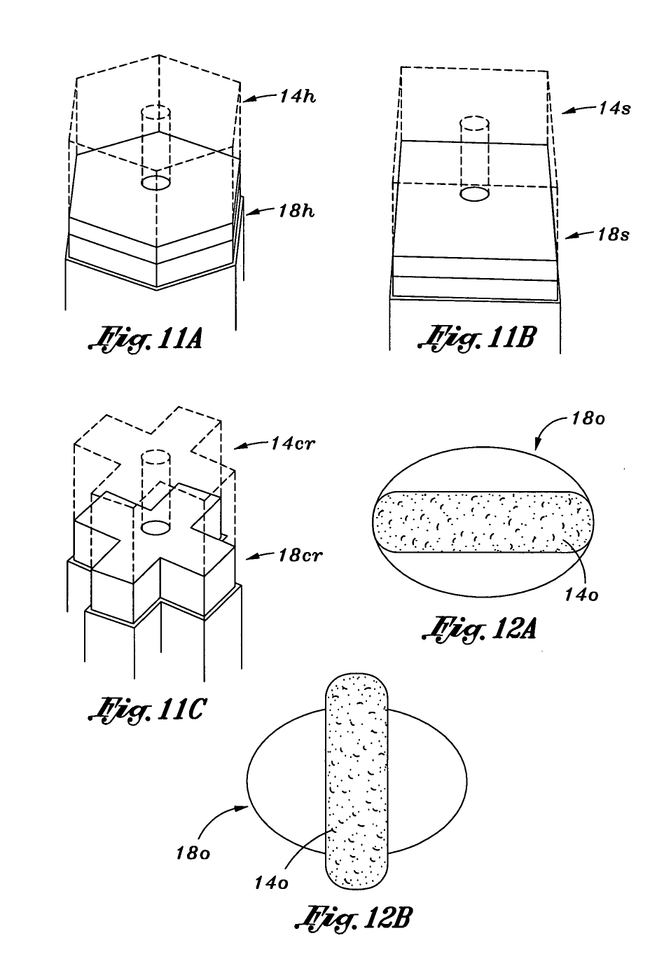

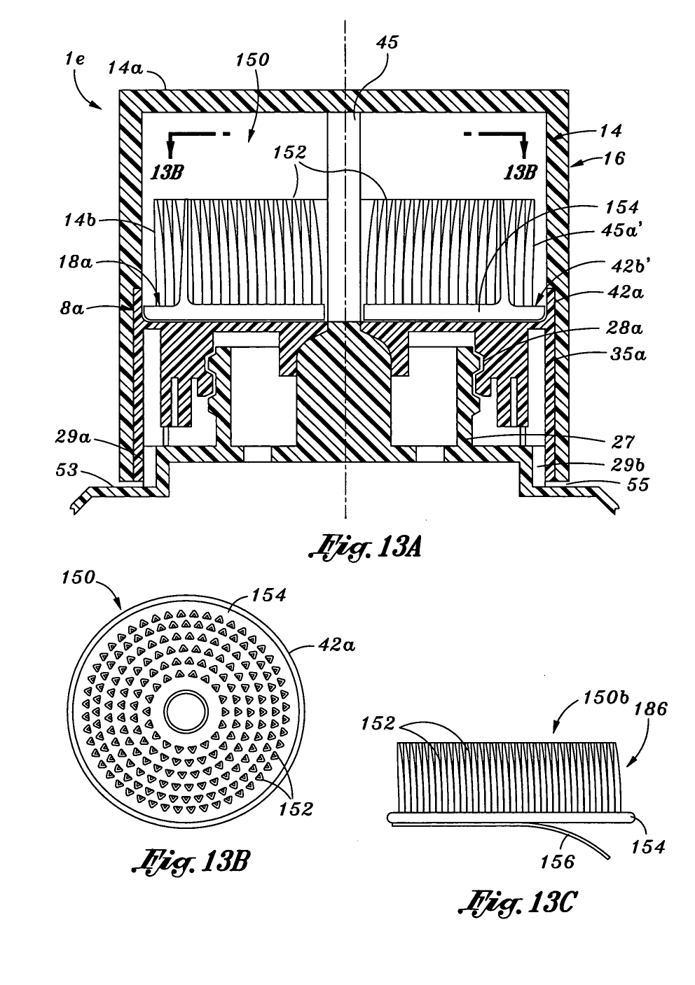

In the alternate embodiments shown in FIGS. 10 through 12B, an applicator that is able to absorb the fluid material in the container 10 is used to apply this material to whatever the consumer wishes. Depending on the particular fluid material being dispensed and/or the particular application, the applicator may be a soft, porous material such as foam plastic such as, for example, open cell polyurethane foam; it may be made of several different types of materials in multiple layers or otherwise; and it may have several different shapes. FIGS. 10 through 12 depict some alternate shapes for the applicator, such as: a triangular shaped applicator 14t (shown in phantom) mounted on a triangular shaped dispenser cap 18t as depicted in FIG. 10; a hexagonal shaped applicator 14h (shown in phantom) mounted on a hexagonal shaped dispenser cap 18h as depicted in FIG. 11A; a square shaped applicator 14s (shown in phantom) mounted on a square shaped dispenser cap 18s as depicted in FIG. 11B; a cross shaped applicator 14cr (shown in phantom) mounted on a cross shaped dispenser cap 18cr as depicted in FIG. 11C; and an oval shaped applicator 140 mounted on a oval shaped dispenser cap 18o depicted in FIGS. 12A and 12B. The dispenser caps 18t, 18h, 18s, 18cr, and 18o are similarly in construction and function to the cylindrical dispenser cap 18. The oval shaped applicator 140 has the added advantage that its position indicates whether the cap is open (FIG. 12B) or closed (FIG. 12A).

FIGS. 13A Through 13C

The embodiment of this invention, dispenser 1e, depicted in FIGS. 13A through 13C employ an applicator 150 using stiff bristles 152 which may have triangular cross-sectional configuration. The applicator 150 comprises a substantially flat support member 154 and a plurality of stiff bristles 152 projecting outward from this support member substantially at a right angle to the support member. As shown in FIG. 13B, the support member 154 has a circular shape with a diameter substantially identical to the diameter of the cover lip 42a of the cover member 35.

The cover lip 42a provides a receptacle portion 42b′ and the support member 154 is configured to fit snugly into the receptacle portion yet enabling the applicator 150 to be detached. The support member 154 may have a diameter slightly greater than the diameter of the receptacle portion 42b′ and be force fitted into this receptacle portion and not easily removed therefrom. The support member 154 may have a diameter about equal to the diameter of the receptacle portion 42b′ with an adhesive surface that bonds the applicator 150 to the cover member 35. As shown in FIG. 13C, an extra applicator 150b may be provided with the dispenser 1e that has a removable cover sheet 156 covering the adhesive surface. The cover sheet 156 is removed when the extra applicator 150b is used to replace the applicator 150 when it wears out.

FIGS. 14A Through 14C

The embodiment of this invention, dispenser If, depicted in FIGS. 14A through 14C employs a blow molded container 10b that is highly flexible and is substantially identical in shape to the container 10 illustrated in the other embodiments. In blow molding, a lower end LE of the container 10b is initially open, and subsequently closed and sealed after filling the container 10b with the fluid material to be dispensed. The lower end LE of the container 10b may include an eyelet 8. The eyelet 8 allows a seller to display the dispenser of this embodiment in a number of ways: (1) by hanging it upside down, or (2) resting on the top surface 75 of the enclosure 16. Displaying the dispenser near the point of sale may be advantageous. The inclusion of an eyelet is not limited solely to the blow molded dispenser If but may be included in any previous or subsequent dispensers, and would have the same functions and benefits.

When using blow molding, a hollow dispensing end DE of the container 10b is too flexible to support a cap 18d and must be made more rigid. The dispensing end DE includes a hollow stepped cylindrical member 107 and a threaded wall 108 which forms a cavity 102. The cap 18d is functionally substantially identical to the caps of the embodiments discussed above and, for example, may employ the cover member 35r with the dispensing end DE having an exterior like that of the base member 24g. The main difference is the lack of the rigidity of the dispensing end DE that must be accommodated. To achieve this, an additional component, a rigid insert 100, is employed. This rigid insert 100 typically is an injected molded, hard plastic. The insert 100 and the dispensing end DE are each designed so that there matching surfaces are congruent. Thus when the insert 100 is placed on the dispensing end DE the insert sidewall 104 fits snugly within the cavity 102 and the cylindrical member 107 fits snugly within a hollow tower 11 of the insert 100. The side of the insert 100 facing the cover member 35r has an external configuration substantially like that of the external surface of the base member 24g. In other words, the rigid insert 100 upon insertion into the cavity 102 forms in the dispensing end DE a mating surface capable of mating with an internal surface of a cover member 35r of the cap 18d.

In this embodiment, the rigid insert 100 includes a floor F3 that merges with the sidewall 104. From floor F3 projects a central, stepped, cylindrical, hollow tower 11. In the floor F3 are holes a1 and a2 that, upon inserting the rigid insert 100 into the cavity 102, are to be aligned with holes a3 and a4 in a floor F4 of the cavity 102. These holes a1, a2, a3 and a4 correspond to the holes 30g in the base member of the dispenser shown in FIG. 7A. The tower 11 has an interior cavity 11a with a configuration substantially identical to the stepped cylindrical member 107, and it receives this stepped cylindrical member upon inserting the rigid insert 100 into the cavity 102. The dispensing end DE and the insert 100 fit snug together so the insert does not turn within the cavity, and thus mate to form the base member. The rigid insert 100 in the cavity 102 imparts structural strength to the dispensing end DE and thus provides a rigid cap 18d with a cover member 35r that can be rotated about a base member similar to the other embodiments discussed above.

FIGS. 15A Through 15C

The embodiment of this invention, dispenser 1g, illustrated in FIGS. 15A through 15C depicts a dispenser employing a container 10 having a cap 18e including an applicator 14e having a plurality of orifices 101 therein and a top enclosure 16e with a plurality of parallel pins 45e extending longitudinally at substantially a right angle to the interior surface of the top wall 16a of the enclosure. With the top enclosure 16e seated on the dispenser's cap 18e as shown in FIG. 15C, the individual pins 45e have passed through individual orifices 101 thus sealing them. The top enclosure 16e is detached prior to dispensing the contents of the container 10.

The cap 18e includes a cover member 106 and the base member 23b like that shown in FIG. 7A. The cover member 106 is similar to the cover member shown in FIG. 7A except that it has a higher lip 42e defining a receptacle portion 109e in the cover member 106. As discussed above in connection with the embodiment shown in FIGS. 7 through 7I, the cover member 106 is at the dispensing end of the container 10 and mounted to rotate relative to the base member 23b so that in a first position the flow of fluid material from the container 10 is prevented and in a second position the flow of material from the container is allowed. The individual pins 45e block the orifices 101 upon attaching the enclosure 16e to the cap 18e, so if the cap is left open accidentally, spills are avoided or inhibited.

The applicator 14e comprises a dome top wall member 103 integral with a cylindrical sidewall 105. The dome shaped top wall member 103 has a diameter slightly greater than or equal to the outside diameter of the cover sidewall 42, while the applicator 14e sidewall 105 has a diameter slightly less than the diameter dome shaped top wall 103, but equal to or slightly greater than the internal diameter of the cover sidewall 42. Thus the applicator 14e is configured to fit snug within the receptacle portion 109e with an overhanging edge 108e that abuts the top of the lip 42e when the applicator 14e is forced into the receptacle portion 109e of the cover member 106. With the applicator 14e inserted into the receptacle portion 109e, a chamber is formed that holds fluid material as it is dispensed from the container 10. The dome top wall member 103 with the plurality of orifices 101 therein form, at least in part, a passageway 15e extending through the cap 18e. Other portions of the passageway 15e include the central opening 37a in the cover member 106 and the holes 26a in the base member 23b. Thus, with the top enclosure 16e detached and the cap 18e in an open position, fluid material flows from the container 10 through the holes 26a, out the central opening 37a into the chamber 109e, and then out the orifices 101 covering the exterior surface of the dome top wall member 103.

FIG. 16

The embodiment illustrated in FIG. 16 holds a plurality of applicators. As depicted in FIG. 16, a sponge applicator 14b is mounted to the top outer surface S2 of the cover top wall 38 in a manner that allows it to be removed easily. In this embodiment, extra sponge applicators 14c and 14d are stored in an enlarged top enclosure 16d. The applicator 14b and the extra applicators 14c and 14d each have an exterior, bottom surface coated with a low-tack adhesive to facilitate easy removal. The low-tack adhesive surfaces of the extra applicators 14c and 14d are each covered with a removable sheet 19 that is stripped away when the applicator 14b is to be replaced. The extra applicators 14c and 14d are approximately the same size and shape as the applicator 14b and each applicator 14b, 14c, and 14d has a longitudinal passageway 15a. These passageways 15a are aligned when the applicators 14b, 14c, and 14d are stacked upon each other as shown in FIG. 16. A central, elongated pin 45b projecting inward from the inside surface of the top of the enclosure 16d extends through the aligned passageways 15a and engages the cap 18 as discussed above.

FIGS. 17A Through 17D-Paint Merchandising Method

Any of the embodiments of the dispensers discussed above may be used to dispense paint according to the paint merchandising method of this invention. In accordance with this method, the container 10 used has only a limited capacity, for example, about 3 to 6 ounces, typically no more than about 8 ounces. For illustration purposes, the dispenser 1a having such a limited capacity container 10 will be discussed in connection with a paint merchandising method of this invention. This method helps consumers select a color of paint that works best for what they need.

FIGS. 17A through 17D illustrate one scenario using the dispenser 1a where the container 10 holds only a small quantity of paint, that is,

(a) enough paint to allow a consumer to see the paint color after being applied to an object, e.g. any surface, or (b) to perform touch up work. The paint dispenser 1a may include one or more means imprinted on the container 10 (FIG. 1) of identifying the color of paint contained within the container, for example: A text description 10e (palm tree green), a numerical representation 10n, and a barcode representation 10bc. The consumer can use the first two representations, text 10e, and numerical 10n, to order larger quantities of the paint contained within the paint dispenser 1a by either phoning in the information (FIG. 17C) or entering it through an online ordering system over a global computer network (the internet). Alternatively, the consumer can bring in the dispenser 1a and have a salesperson scan the barcode 10bc (FIG. 17D) using a conventional bar code reader 85.

FIG. 17A shows a consumer 80 discussing with a salesperson 87 the purchase of paint and the selection of paint colors available. The consumer 80 may select multiple dispensers 1a, each holding a different paint color. These dispensers 1a may be purchased or given as a courtesy sample, for example, 2 or 3 dispensers 1a, each containing a different color paint. The consumer 80 brings these paint dispensers 1a to wherever a surface 83 is that he or she wishes to paint. The consumer 80, using the dispensers 1a, applies the paint in as big or small a swatch 90 as he or she needs to be able to determine which color they prefer. To apply the paint to the surface 83, the costumer first removes the top enclosure 16, rotates the cap 18 into the open position, and then squeezes the container 10, filling the applicator 14 with paint. Next, the consumer places the applicator 14 on the surface 83 to be painted and compresses the applicator to release the paint from the applicator as the consumer moves the applicator across the surface 83. Alternatively the consumer 80 may squeeze the container 10 simultaneously with the act spreading the paint. FIG. 17B depicts the consumer 80 in the process of applying three different colors to the desired surface 83. Upon completion of this task, the consumer will be able to judge which color looks best on the surface 83. Once the consumer 80 has decided on a best color, the consumer 80 may then call in an order (FIG. 17C) of the desired quantity of the selected paint color by reading either the name 10t or the numerical code 10n off the container 10. Alternatively, the consumer 80 may bring in container 10 and have an employee scan the barcode 10bc off the container 10 (FIG. 17D) and then mix up the desired quantity of the selected paint. Consequently, the method of this invention thus ensures convenience, consumer satisfaction, and simplicity in ordering paint.

### SUMMARY

The above-described dispensers may be used to dispense a wide variety of fluid materials held within the container. Skin care products such as, for example, cosmetics, micro-dermal abrasive solutions, antiseptics, ointments, creams, topical solutions, etc. are suited to be applied to the skin of a person using the applicator attached to the cap, especially a sponge-type applicator. Deodorants may be applied using the embodiment illustrated in FIGS. 15A through 15C. Other fluid materials such as depilatory creams, shoe cleaners and polish, coatings such as, for example, paint, stains, varnish, liquid wax, many types of chemicals, etc. may be dispensed using this invention.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A dispenser comprising
a container adapted to hold a fluid material having an end from which said material is dispensed,
a cap attached to the container including a passageway through which the material flows, said cap comprising a base member attached to the end of the container and a cover member having at an exterior thereof an applicator element onto which flows the material exiting the container,
said base and cover members being mounted to each other to rotate relative to each other and move between a closed position preventing the flow of the fluid material through the passageway and an open position allowing the flow of material from the container and through the passageway onto the applicator element, and
a detachable enclosure mounted to the cap that covers the applicator element and at least partially blocks the passageway.

2. The dispenser of claim 1 where the applicator element comprises a plurality of bristle elements projecting outward from a support member.

3. The dispenser of claim 2 where the support member has an exterior surface with an adhesive thereon covered by a removable sheet that is removed prior to attaching the applicator element to the cap.

4. The dispenser of claim 2 where the base member includes a top with a receptacle portion and the support member is configured to fit snugly into the receptacle portion yet enabling the applicator to be detached.

5. The cap of claim 2 where at least some of the bristle elements have a triangular cross-sectional configuration.

6. The dispenser of claim 1 where the applicator element comprises an absorbent material.

7. The dispenser of claim 6 where the applicator element has an exterior surface with an adhesive thereon that adheres to a surface of the cover member.

8. The dispenser of claim 1 where the applicator element is detachably connected to the cover member and the enclosure includes an auxiliary applicator element that is used to replace the applicator element initially attached to the cover member.

9. The dispenser of claim 8 where the auxiliary applicator element includes an exterior surface with an adhesive thereon covered by a removable sheet that is removed prior to attaching the auxiliary applicator element to the cap.

10. The dispenser of claim 1 where the applicator element comprises a dome member with a plurality of orifices therein that form at least in part the passageway and the enclosure includes a plurality of pins therein, each individual pin being aligned with one of the individual orifices to block the orifices upon attaching the enclosure to the cap.

11. The dispenser of claim 1 where the enclosure includes a closed top end with an external abrasive surface.

12. A dispenser comprising
a container adapted to hold and dispense a fluid material,
a cap attached to the container including a base member and a cover member attached to the base member, each said member having an opening therein,
said base and cover members being mounted to move relative to each other so that in a first position the flow of material through said openings is prevented and in a second position the flow of material through said openings is allowed,
an applicator element attached to the cover member onto which flows the fluid material, said applicator element having a passageway therethrough, and
a detachable enclosure that has an open end having a configuration that enables the enclosure to fit snugly onto said cap and an internal pin element that, with the enclosure fitting snugly on the cap, extends into the passageway in the applicator element to block the opening in at least the cover member.

13. The dispenser of claim 12 where said openings in the base and cover members are aligned and said base and cover members are mounted to rotate relative to each other to move between the first and second positions, maintaining said alignment of the openings during rotational movement.

14. The dispenser of claim 12 where the cover member includes a raised peripheral element surrounding the applicator element.

15. The dispenser of claim 12 where the enclosure includes a closed top end with an external abrasive surface.

16. The dispenser of claim 12 where the enclosure includes a closed top end, an open bottom end, a sidewall of predetermined length connecting the top and bottom ends, and an inward projecting retainer element at the bottom end enabling the enclosure to be detachably connected to an edge of the cover member or the base member, said internal pin element having a length that is less than the length of the sidewall yet of sufficient length to block the opening in at least the cover member when the enclosure is connected to an edge of the cover member or the base member.

17. The dispenser of claim 16 where the enclosure includes at least one vent opening.

18. The dispenser of claim 12 where the applicator element comprises a sponge.

19. The dispenser of claim 12 where the applicator element includes an exposed flocked surface.

20. The dispenser of claim 12 where the applicator element has a slanted top surface.

21. The dispenser of claim 12 where the applicator element comprises a plurality of bristle elements projecting outward from a support member.

22. A dispenser comprising
a container adapted to hold a fluid material having an end from which said material is dispensed,
a cap attached to said end of the container, said cap including a plug element, a base member having an opening therein, and a cover member having an opening therein, said openings being aligned and the base and cover members being mounted to rotate relative to each other so that in a first position the plug element is inserted into at least one opening to prevent the flow of material from the cap and in a second position is withdrawn from said one opening to allow the flow of material from the cap,
an applicator element attached to the cover member onto which the fluid material flows when said base and cover members are in the second position, said applicator element having a passageway therethrough aligned with said openings in the base and cover members, and
a detachable enclosure that has an open end having a configuration that enables the enclosure to fit snugly onto said cap and an internal pin element that, with the enclosure fitting snugly on the cap, extends through the passageway in the applicator element to block the opening in at least the cover member.

23. The dispenser of claim 22 where said plug element is positioned within the cap and is attached to the base member.

24. The dispenser of claim 22 where the cover member includes a raised peripheral element surrounding the applicator element.

25. The dispenser of claim 22 where the enclosure includes a closed top end with an external abrasive surface.

26. The dispenser of claim 22 where the enclosure includes a sidewall of predetermined length connecting a closed top end and the open end of the enclosure, said internal pin element having a length that is less than the length of the sidewall yet of sufficient length to block the opening in at least the cover member when the enclosure is connected to the cap.

27. The dispenser of claim 26 where the enclosure includes at least one vent opening.

28. The dispenser of claim 22 where the applicator element comprises a sponge-type material.

29. The dispenser of claim 22 where the applicator element includes an exposed flocked surface.

30. The dispenser of claim 22 where the applicator element has a slanted top surface.

31. The dispenser of claim 22 where the applicator element comprises a plurality of bristle elements projecting outward from a support member.

32. A dispenser comprising
a container blow molded to provide a flexible fluid retaining structure including a dispensing end from which a fluid material is dispensed, said dispensing end having an exterior threaded surface and an interior cavity with a wall element having at least one opening therein through which fluid material may flow,
a cap attached to said end and including a rigid member having at least one opening therein and a cover member having an applicator element onto which flows the fluid exiting the container,
the rigid member being inserted into the interior cavity in the dispensing end of the container with said opening in the cavity aligned with the opening in the wall element of the cavity, said rigid member being configured to fit snugly within said cavity to maintain the alignment of the openings and provide rigidity to said dispensing end,
said cover member having an internal threaded surface that engages the exterior threaded surface at said dispensing end upon attaching the cover member to said dispensing end,
said cover member being mounted to rotate relative to the rigid member and move between a closed position preventing the flow of the fluid material through the aligned openings and an open position allowing the flow of fluid material through the aligned openings and from the container onto the applicator.

33. The dispenser of claim 32 including
a passageway extending through the applicator and the cap and including the aligned openings and
a detachable enclosure mounted to the cap that covers the applicator and includes an internal pin element that, upon attaching the enclosure to the cap, at least partially blocks the passageway.

34. The dispenser of claim 32 where the applicator comprises a plurality of bristle elements projecting outward from a support member.

35. The dispenser of claim 32 where the applicator comprises an absorbent material.

36. A dispenser comprising
a container adapted to hold a fluid material having an open end from which said material is dispensed,
a cap attached to said open end of the container including a cover member having an opening therein,
said cover member being mounted to rotate relative to the open end so that in a first position the flow of material from the container is prevented and in a second position the flow of material from the container is allowed,
said cover member having a receptacle portion therein with a wall including an opening through which fluid material is dispensed and an applicator element configured to fit snug with the receptacle portion, said applicator element being inserted into the said receptacle portion to form a chamber that holds fluid dispensed through the opening, said chamber having a top wall with a plurality of orifices therein, and
an enclosure member including a plurality of pin elements therein in a predetermined arrangement so that, upon attaching the enclosure member to the cap, each individual pin element is aligned with one of the individual orifices and block the orifices.

37. In combination, a cap for a dispenser of fluid material and an enclosure therefor, wherein
said cap includes
a base member adapted to be attached to an open end of a dispenser and having an outer edge and a centrally located plug element,
a cover member having a top surface with an opening centrally located therein, an outer edge, and a raised element on the top surface along a periphery of said top surface, said opening and plug element being aligned,
said cover member being mounted to rotate relative to the base member when said base member is attached to an open end of a dispenser, said cover member upon rotation in one direction moving between a closed position with the plug element inserted into the opening to prevent the flow of material from the cap and an open position with the plug element withdrawn from said opening to allow the flow of material from the cap, and upon rotation in a direction opposite to said one direction, moving between the open position and the closed position,
an applicator element seated on the top surface and having an inside surface attached to the top surface with said raised element substantially surrounding at least a lower portion of the applicator element, said applicator element having a passageway therethrough aligned with said opening in the cover member, and
said enclosure includes
a closed top end, an open bottom end, an inward projecting retainer element at the bottom end enabling the enclosure to be detachably connected to the outer edge of the cover member or the base member, and an internal pin element attached to the top end and projecting inward towards the open bottom,
said internal pin element having a predetermined length such that, with the enclosure attached to the cap and the retainer element engaging said outer edge of the cover member or the base member, the pin element extends through the passageway in the applicator element and blocks the opening in the cover member.

38. The combination of claim 37 where the base and cover members each have a substantially circular configuration.

39. The combination of claim 37 where the base and cover members each have a substantially triangular configuration.

40. The combination of claim 37 where the base and cover members each have a substantially hexagonal configuration.

41. The combination of claim 37 where the base and cover members each have substantially the same length and the cover member has a width that is substantially less than the width of the base member and in the closed position the base and cover members are aligned lengthwise and in the open position the cover member is oriented at an angle with respect to the base member.

42. The combination of claim 37 where the internal pin element has at an inner terminal end a wall defining a cavity and the opening has a groove substantially surrounding the opening, said wall fitting snugly into said groove when the members are in the closed position.

43. The combination of claim 37 including a raised wall substantially surrounding the opening to provide an open space and the internal pin element has an inner terminal end that fits snugly into said open space when the members are in the closed position.

44. A dispenser cap including
a base member adapted to be attached to an open end of a dispenser and having a plug element,
a cover member having a top surface with an opening therein and a raised element on the top surface along a periphery of said top surface, said opening and plug element being aligned,
said cover member being mounted to rotate relative to the base member when said base member is attached to an open end of a dispenser, said cover member upon rotation in one direction moving between a closed position with the plug element inserted into the opening to prevent the flow of material from the cap and an open position with the plug element withdrawn from said opening to allow the flow of material from the cap, and upon rotation in a direction opposite to said one direction moving between the open position and the closed position, and
an applicator element seated on the top surface and having an inside surface attached to the top surface with said raised element substantially surrounding at least a lower portion of the applicator element, said applicator element having a passageway therethrough aligned with said opening in the cover member.

45. An enclosure adapted to be detachable connected to a dispenser cap with an opening therein, said enclosure including
a closed top end, an open bottom end, an inward projecting retainer element at the bottom end enabling the enclosure to be detachably connected to an inner edge of the dispenser cap, and an internal pin element attached to the top end and projecting inward towards the open bottom,
said internal pin element having a predetermined length such that, with the enclosure attached to the cap and the retainer element engaging said inner edge, the pin element blocks the opening in the cover member.

46. The enclosure of claim 45 including at least one vent opening.

47. The enclosure of claim 45 where the closed top end has an external abrasive surface.

48. A dispenser including
a cap and an enclosure detachably connected to the cap,
said cap including a base member and a cover member with an opening therein, said the cover member mounted to rotate relative to the base member between an open position where fluid material is allowed to exit the opening and a closed position where fluid material is prevented from exiting the opening,
an applicator element attached to the cover member having a passageway therethrough aligned with said opening in the cover member, and
said enclosure including an open bottom end having at or nearby said open bottom end an inward projecting annular retainer element enabling the enclosure to be detachably connected to the outer edge of the cover member or the base member, and an internal pin element projecting inward towards the open bottom end,
said internal pin element having a predetermined length such that, with the enclosure attached to the cap and the retainer element engaging said outer edge of the cover member or the base member, the pin element extends through the passageway in the applicator element and blocks the opening in the cover member.

49. A dispenser including
a cap and an enclosure detachably connected to the cap,
said cap including a base member and a cover member with an opening therein, said the cover member mounted to rotate relative to the base member between an open position where fluid material is allowed to exit the opening and a closed position where fluid material is prevented from exiting the opening, and
an applicator element attached to the cover member having a passageway therethrough aligned with said opening in the cover member, said enclosure including an inwardly projecting internal pin element, said internal pin element having a predetermined length such that, with the enclosure attached to the cap, the pin element extends through the passageway in the applicator element and blocks the opening in the cover member,
said pin element including at least one annular element that is in a mating relationship with an annular element on a plug element on the base member that fits in the opening when the cover member is in the closed position.

50. The dispenser of claim 49 where the cover and base members each include at least one annular element, said annular elements mating with each other when in the cover member is in the closed position.

51. A method of merchandising paint of different colors comprising
(a) providing a plurality of compact paint dispensers, individual dispensers containing no more than 8 ounces of a paint and at least some of the individual dispensers containing a paint of a color different than paint within other dispensers, individual dispensers having indicia thereon that identifies the color of the paint therein and including a paint applicator having a manually actuated open and closure mechanism to enable a consumer to release selectively paint therefrom,
(b) selecting one or more paint dispensers and applying as a test specimen paint therefrom to a surface to enable a consumer to identify a desired color of paint, and
(c) subsequent to step (b) ordering a quantity of paint of at least one quart and identifying the color of paint being ordered using the indicia on the dispenser that provided the desired color of paint.

52. The method of claim 51 where the indicia is machine readable.

53. The method of claim 51 where the indicia is imprinted on the dispenser in a form understandable to a human consumer.

54. A method of merchandising paint of different colors comprising
(a) providing at a sales source a plurality of compact paint dispensers, individual dispensers containing no more than 8 ounces of a paint and at least some of the individual dispensers containing a paint of a color different than paint within other dispensers, individual dispensers having indicia thereon that identifies the color of the paint therein and including a paint applicator having a manually actuated open and closure mechanism to enable a consumer to release selectively paint therefrom,
(b) using one or more paint dispensers obtained from said sales source, applying as a test specimen paint to a surface at a location remote from the sales source to enable a consumer to identify a desired color of paint to be used to paint said surface with a quantity of paint substantially greater than that contained within an individual dispenser or dispensers being used to apply paint as a test specimen, and
(c) subsequent to step (b), ordering from the sales source a quantity of paint of at least one quart and identifying the color of paint being ordered by the indicia on the dispenser that provided the desired color of paint.

55. The method of claim 54 where the indicia is machine readable and the order is placed by returning the dispenser to the sales source to enable the indicia to be machine read by the sales source.

56. The method of claim 54 where the indicia is imprinted on the dispenser in a form understandable to a human consumer to enable a human consumer to place an order with the sales source using said indicia to identify the color of paint being ordered.

57. A method of merchandising paint of different colors comprising
(a) providing at a sales source a plurality of compact paint dispensers from which a consumer selects one or more to sue to paint a test surface, each individual dispenser containing a paint of a predetermined color and including a paint applicator having a manually actuated open and closure mechanism,
(b) using one or more paint dispensers obtained from the sales source, applying as a specimen paint from a selected dispenser to the test surface to enable a consumer to identify a desired color of paint to be used to paint the surface with a quantity of paint substantially greater than that contained within an individual dispenser or dispensers being used to apply paint to the test surface, and
(c) subsequent to step (b), ordering a larger quantity of paint and identifying the color of paint being ordered.

58. A method of applying a fluid skin care product to the skin of a person comprising
providing a dispenser including a container holding a fluid skin care product, a twist-open cap on the container, an applicator attached to the cap, a passageway through which the skin care product flows upon twisting the cap open, and a detachable enclosure mounted to the cap that covers the applicator and at least partially blocks the passageway,
removing the enclosure and twisting open the cap, and
applying the skin care product to the skin of the person using the applicator.
